(19) United States
(12) Patent Application Publication
(10) Pub. No.: US 2024/0074453 A1
(43) Pub. Date: Mar. 7, 2024

(54) In-Cup Frozen Mix Shaving and Blending System with Counter-Rotating Blade Subassemblies

(71) Applicant: John Michael Herbert, Winchester, MA (US)

(72) Inventors: John Michael Herbert, Winchester, MA (US); Bryan R. Hotaling, Harvard, MA (US); Matthew Naples, Boxborough, MA (US); Anthony Catacchio, Littleton, MA (US); Christian Cooper, Arlington, MA (US); Michael Gallitto, Framingham, MA (US); William B. Herbert, Winchester, MA (US); Louis B. Herbert, Somerville, MA (US)

(21) Appl. No.: 18/240,439

(22) Filed: Aug. 31, 2023

Related U.S. Application Data
(60) Provisional application No. 63/403,028, filed on Sep. 1, 2022.

(51) Int. Cl. A23G 9/12; A23G 9/04; A23G 9/22

(52) U.S. Cl. CPC A23G 9/12; A23G 9/045; A23G 9/224

(57) ABSTRACT

A shaving and blending system for shaving and blending a frozen mix within a container. An inner blade subassembly rotates in a first direction to shave the frozen mix over an inner shaving zone Zᵢ and an outer blade subassembly with blades in a common plane with the blades of the inner blade subassembly rotates in a second, opposite direction to shave the mix over an outer shaving zone Zₒ. The blades of the outer blade subassembly pivot about proximal ends thereof whereby the outer diameter of the outer shaving zone Zₒ is adjustable. Edges of the blades of the outer blade subassembly are disposed at an outward angle with distal blade ends disposed rotationally ahead of proximal blade ends. The frozen mix thus tends to press the blades outwardly during shaving to expand the outer circumference of the outer shaving zone Zₒ to adapt to varying container diameters.

### RELATED APPLICATION

This application claims priority to U.S. Provisional Patent Application No. 63/403,028, filed Sep. 1, 2022, which is incorporated herein by reference.

### FIELD OF THE INVENTION

The present invention relates generally to systems and methods for mixing and blending. More particularly, disclosed herein are a system and method for shaving and blending a frozen mix with a liquid within its original cup or other container by operation of a shaving and blending assembly with self-adjusting, counter-rotating blade subassemblies that automatically adjust to varying container diameters while avoiding inducing a spinning of the frozen mix within the container to yield a finely divided, blended frozen mixture within a single container, which could be made of 100% recyclable material, in which the frozen product and liquid mixture can be shaved, blended, and consumed.

### BACKGROUND OF THE INVENTION

There are many circumstances in which a person may wish to enjoy a mixed frozen beverage. For instance, individuals seeking to pursue a healthy lifestyle may craft frozen smoothies to enjoy blended mixes of fruits and vegetables in a convenient, portable, and often delicious way. Other individuals may wish to prepare a frozen mixed cocktail, possibly with the addition of alcohol.

Under practices of the prior art, a person seeking such a smoothie, slushie, or other mixed frozen beverage will typically first require a motorized blender. Then, he or she must supply and insert a sufficient volume of ice and various ingredients into the blender jar. If a smoothie is to be produced, the individual must have the desired fruit or vegetables on hand, and those must be inserted together with any other planned ingredients, such as protein mix, sweetener, or other ingredients, into the blender jar with the volume of ice. Then, the blender jar must be tightly covered, and the blender motor must be actuated to induce the rotary blades of the blender into action. The sharp, rapidly spinning blades slice, pulverize, and mix the contents of the blender jar in a process that ideally results in a well-mixed frozen smoothie or other beverage.

The process of making a mixed frozen beverage thus often requires the combining of frozen water in the form of ice crystals with soluble and insoluble matter. Soluble matter may include, for example, the soluble interior of a piece of fruit while insoluble matter might include the insoluble skin of the fruit. Each such mixed frozen beverage thus comprises a mixture of frozen water from the ice and soluble and insoluble components of the remaining ingredients usually along with a liquid, such as water, milk, or another liquid. In this regard, it will be understood that the incorporated ice is 100% water while frozen fruit and vegetables may be over 90% water. Similarly, consumable liquids, whether in the form of alcohol, oat milk, soy milk, or in any other form, likewise have a large percentage of water.

While the result in the case of a fruit, vegetable, or protein smoothie can indeed be a healthy and delicious blended ice drink and while frozen mixed adult drinks can be highly enjoyable, the mixing process has significant drawbacks. By way of example and not limitation, the process of mixing by operation of the high impact pulverizing and blending action of high speed rotary mixer blades of prior art blenders is exceedingly loud and relatively violent. Indeed, in view of the loud nature of the mixing process using prior art blenders, a person may opt to forego such a beverage, particularly in the early morning or late at night, for fear of disturbing others.

Furthermore, mixing with a prior art blender often results in air pockets that require the blender to be shut off to allow manual intervention to release the air pocket. Even further, the mixing process quite often leaves the user with a cumbersome, messy result. The blender jar, the cover, and the blades must be cleaned, often along with the countertop and any recipient vessels, and one must dispose of the remnants of any peels, skins, or containers of ingredients.

Even after what the user may perceive as a successful blending process, a smoothie or other frozen mix prepared with a blender may be inconsistently mixed, possibly with undesirable chunks of ice, fruit, or vegetable. Meanwhile, it is known that benefits can be achieved by breaking the components of smoothies and into smaller, evenly-sized particles. For instance, where such raw materials are broken down into smaller particles, improved flavor can be realized, and reducing the size of the constituent particles can provide a consistent taste and texture. Furthermore, breaking raw materials into smaller particles can reduce undesirable sedimentation and separation and can avoid the aeration inconsistencies caused by high-speed blenders. Many fruits and vegetables, such as oranges, strawberries, apples, and tomatoes, contain the natural stabilizer pectin, which is a hydrocolloid and aids in the aeration process like cream when it is whipped. However, this advantageous reduction in consistent particle size may not be adequately or completely achieved with a manually operated blender.

Large and relatively complex commercial puree machines, colloid mills, and other machines are known to reduce particle size in a controllable way. For instance, colloid mills can reduce the size of solid particles in a liquid suspension. To achieve the desired particle size in a colloid mill, large particle sizes are directed to a stator and a rotor, and the processed materials then undergo a high degree of calculated shearing and cutting between the metal-toothed surfaces of the stator and the rotor. Once processed, a colloidal suspension results with a dispersed phase comprising suspended particles and a continuous phase comprising the liquid medium of suspension.

The ability to produce a premade and measured suspension of a smoothie or other beverage can be highly desirable for the reasons stated herein. However, the average home blender cannot achieve reduced particle size in a consistent and convenient manner, and the size, complexity, and expense of the currently needed machinery render its use in the consumer environment effectively impossible. Accordingly, producing a smoothie or other frozen beverage as a colloidal suspension with a consistent and controlled particle size is at best difficult in the consumer environment.

Systems have been disclosed wherein the frozen contents of a specialized container are blended and prepared for consumption. However, many such systems rely on complex container structures that often incorporate blade assemblies within the container thereby exposing the consumer to risk of injury during consumption or requiring transfer to a new container thereby increasing the inconvenience to the consumer and the lack of environmental friendliness of the system.

It is thus apparent to the present inventors that being able to produce a frozen beverage as a consistent suspension in the home environment within a given container, such as an environmentally-friendly disposable cup, would be highly desirable. It is further apparent that a system capable of fully blending a frozen colloidal suspension or other frozen contents of a container in place within the container would represent a marked advance in the art.

However, producing a suspension from a frozen mix within a cup or other container requires the resolution of a number of important challenges. Among them is the ability to blend and mix the frozen contents of the container while avoiding causing the contents to spin within the container or causing the container to spin within the apparatus thereby frustrating the shaving, blending, and mixing process. A further challenge is to shave and mix the frozen contents of a container substantially entirely, particularly where the cup or other container tapers in diameter. Yet another challenge presented by shaving and mixing the frozen contents of a container is doing so smoothly and quietly. Still yet another challenge is producing a shaved and blended mix with a consistent and controlled particle size.

### SUMMARY OF THE INVENTION

With an awareness of the foregoing, the present inventors thus set forth with the basic object of providing a system and method for shaving and blending the frozen contents of a cup or other container, potentially in combination with a liquid, in place within that container.

An additional object of embodiments of the invention is to provide a system for shaving and blending the frozen contents of a container together with a liquid within a cup, such as a cup composed of a recyclable paper based material or another container, while avoiding causing the frozen mix to spin during the shaving process.

An underlying object of embodiments of the invention is to provide a system and method that enable a frozen suspension to be of a consistent formula in taste and particulate size.

A further underlying object of embodiments of the invention is to provide a system for shaving and blending the frozen contents of a container with a liquid by operation of a blade assembly that is capable of self-adjusting to varying diameters over the height and width of a given container and to adapt to containers of different sizes while not adversely affecting the walls of the container, such as by puncturing, tearing, or otherwise disrupting.

A further object of manifestations of the invention is to provide a system for shaving and blending the frozen contents of a container with a liquid that shaves and blends substantially the entire contents of the container with the liquid while avoiding unmixed chunks and other portions.

Still another object of embodiments of the invention is to provide a system for shaving and blending frozen contents and a liquid within a container that can perform shaving and blending operations in a smooth and quiet manner.

In certain embodiments of the invention, a still further object is to provide a shaving and blending system capable of limiting operation to authenticated containers.

A related object of embodiments of the invention is to provide a shaving and blending system capable of limiting operation to authenticated containers on a single or limited use basis.

These and further objects, advantages, and details of the present invention will become obvious not only to one who reviews the present specification and drawings but also to those who have an opportunity to observe an embodiment of the in-cup shaving and blending system with counter-rotating blade subassemblies in operation. However, it will be appreciated that, although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present invention.

In accomplishing one or more objects of the invention, an embodiment of the shaving and blending system for shaving and blending a frozen mix within a container has a rotatable inner blade subassembly and a rotatable outer blade subassembly. The inner blade subassembly has at least one blade with a blade edge for shaving the frozen mix over an inner shaving zone Zᵢ. The inner blade subassembly is adapted to shave the frozen mix in a first rotational direction. The outer blade subassembly has at least one blade with a blade edge for shaving the frozen mix over an outer shaving zone Zₒ. The outer blade subassembly is concentric with the inner blade subassembly, and the outer blade subassembly is adapted to shave the frozen mix in a second rotational direction opposite the first rotational direction. The inner blade subassembly and the outer blade subassembly are rotatable about a common rotational axis. Under this construction, the shaving and blending system can shave and blend the frozen mix within the container over the inner and outer shaving zones Zᵢ and Zₒ by a rotation of the inner blade subassembly in the first rotational direction and a simultaneous rotation of the outer blade subassembly in the second rotational direction.

The at least one blade of the inner blade subassembly and the at least one blade of the outer blade subassembly have blade edges in a common plane perpendicular to the rotational axis. During shaving of the frozen mix, the inner blade subassembly will thus impart a rotational force on the frozen mix in the first rotational direction while the outer blade subassembly will simultaneously impart a rotational force on the frozen mix in the second rotational direction.

In embodiments of the shaving and blending system, the inner blade subassembly has first and second blades. The first and second blades of the inner blade subassembly project in fixed orientations in substantially opposite directions from the rotational axis.

As disclosed herein, the outer blade subassembly can have first and second blades, each with a proximal end and a distal end and each pivotally retained by the proximal end thereof. The blade edges of the first and second blades of the outer blade subassembly are angled to travel when rotated for shaving at an outward angle relative to a radius emanating from the axis of rotation and with the distal ends of the first and second blades of the outer blade subassembly disposed rotationally ahead of the proximal ends of the first and second blades. With that, the frozen mix will tend to exert a force pressing the first and second blades of the outer blade subassembly to pivot outwardly thereby expanding the outer circumference of the outer shaving zone Zₒ.

Traveler members can be fixed to pivot with the first and second blades of the outer blade subassembly. Each traveler member can have an outer surface that is smooth and arcuate and that extends radially outward of an outer surface of the respective blade of the outer blade subassembly. With that, direct contact between the outer surface of the blade of the outer blade subassembly and the sidewall of the container is avoided whereby damage to the container from the blade is prevented.

According to embodiments of the shaving and blending system, the inner blade subassembly is adapted to engage and rotate with an inner shaft and the outer blade subassembly is adapted to engage and rotate with an outer shaft that concentrically receives the inner shaft. Under this construction, the inner and outer shafts and the inner and outer blade subassemblies can be simultaneously rotated in opposite directions.

The rotation of the inner and outer shafts can be achieved by operation of a motor with an output shaft. A drive assembly for the inner shaft and the inner blade subassembly rotates the inner blade subassembly in the first rotational direction in response to a rotation of the output shaft by the motor in a first rotational direction of the motor. Further, a drive assembly for the outer shaft and the outer blade subassembly rotates the outer blade subassembly in the second rotational direction in response to the rotation of the output shaft by the motor in the first rotational direction.

A bonnet cover is concentrically retained relative to the inner and outer shafts and the inner and outer blade subassemblies to enshroud the container when the shaving and blending assembly is extended to engage the container. The bonnet cover has a container sealing ring for engaging the rim of the container. Under this construction, the bonnet cover can sealingly engage the container thereby to prevent leakage during shaving and blending.

In certain embodiments, the shaving and blending system further includes a container holder with a retainer cup for selectively receiving and retaining the container and for selectively being inserted atop a container support structure aligned with the inner and outer blade subassemblies. The retainer cup has an upper rim. In such embodiments, the bonnet cover can further include a container holder sealing ring for engaging the upper rim of the retainer cup of the container holder. The container holder sealing ring has a diameter greater than the diameter of the container sealing ring. With this, the bonnet cover can enshroud the retainer cup of the container holder to permit a blade cleaning operation of the blade subassemblies and the container sealing ring without risk of mess and leakage.

One will appreciate that the foregoing discussion broadly outlines certain important goals and features of the invention to enable a better understanding of the detailed description that follows and to instill a better appreciation of the inventors' contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

In the accompanying drawing figures:

FIG. 1 is a perspective view of an in-cup shaving and blending system with a self-adjusting, counter-rotating blade assembly according to the present invention with a container prepared for insertion into a container holder of the shaving and blending system;

FIG. 2 is a lower perspective view of the shaving and blending system of FIG. 1 with the system housing removed;

FIG. 3 is a perspective view of the in-cup shaving and blending system with the container holder inserted to permit shaving and blending;

FIG. 4 is a rearward perspective view of the in-cup shaving and blending system;

FIG. 5 is a perspective view of a container holder as disclosed herein;

FIG. 6 is a perspective view of the in-cup shaving and blending system with the system housing and anterior shell portion removed;

FIG. 7 is a perspective view of the in-cup shaving and blending system with the system housing removed and with the shaving and blending assembly in a raised position;

FIG. 8 is a perspective view of the in-cup shaving and blending system with the system housing removed and with the shaving and blending assembly in a lowered position;

FIG. 9 is a lower perspective view of a self-adjusting, counter-rotating blade assembly pursuant to the present invention;

FIG. 10 is a top plan view of the self-adjusting, counter-rotating blade assembly positioned for shaving and mixing within an upper portion of a container;

FIG. 11 is a top plan view of the self-adjusting, counter-rotating blade assembly positioned for shaving and mixing within a lower portion of the container;

FIG. 12 is a partially sectioned view in side elevation of the shaving and blending system with a container retained for shaving and blending and with the blade assembly and the bonnet in raised positions;

FIG. 13 is a partially sectioned view in front elevation of the shaving and blending system with a container retained for shaving and blending and with the blade assembly and the bonnet in raised positions;

FIG. 14 is a partially sectioned view in front elevation of the shaving and blending system with the container retained for shaving and blending with the bonnet lowered into sealing engagement with the container and with the blade assembly lowered to begin shaving the contents of the container;

FIG. 15 is a partially sectioned view in front elevation of the shaving and blending system with the container retained for shaving and blending with the bonnet lowered into sealing engagement with the container and with the blade assembly advanced to the bottom of the container upon completion of a shaving of the contents of the container;

FIG. 16 is a partially sectioned view in front elevation of the shaving and blending system with the container removed, with the bonnet lowered into sealing engagement with the container holder, and with the blade assembly advanced into the inner volume of the container holder for cleaning;

FIG. 17 is an amplified, partially sectioned view in side elevation of a container retained for shaving and blending with the bonnet lowered into sealing engagement with the container and with the blade assembly lowered to begin shaving the contents of the container;

FIG. 18 is an amplified, partially sectioned view in side elevation of the container retained for shaving and blending with the bonnet lowered into sealing engagement with the container and with the blade assembly advanced to the bottom of the container upon completion of a shaving of the contents of the container;

FIG. 19 is an upper perspective view of the shaving and blending system with the system housing and anterior shell portion removed;

FIG. 20 is a perspective view of an alternative embodiment of the in-cup shaving and blending system with a self-adjusting, counter-rotating blade assembly with a container retained for shaving and blending;

FIG. 21A is an upper perspective view of the self-adjusting, counter-rotating blade assembly of FIG. 20;

FIG. 21B is a lower perspective view of the self-adjusting, counter-rotating blade assembly of FIG. 20;

FIG. 22A is a perspective view of the self-adjusting, counter-rotating blade assembly of the shaving and blending system during a shaving of frozen mix within a container;

FIG. 22B is a perspective view of the self-adjusting, counter-rotating blade assembly of the shaving and blending system during completion of a shaving of the frozen mix within the container;

FIG. 23A is a top plan view of the self-adjusting, counter-rotating blade assembly of the shaving and blending system during rotation within an upper portion of a container;

FIG. 23B is a top plan view of the self-adjusting, counter-rotating blade assembly of the shaving and blending system during rotation within a bottom portion of the container;

FIG. 24 is a perspective view of an alternative embodiment of the self-adjusting, counter-rotating blade assembly;

FIG. 25 is a perspective view of the head portion of the self-adjusting, counter-rotating blade assembly of FIG. 24;

FIG. 26 is a partially sectioned view of the gear assembly of a shaving and blending system according to an embodiment of the invention;

FIG. 27 is a partially sectioned perspective view of the self-adjusting, counter-rotating bade assembly of the shaving and blending system coupled with the gear assembly and with a retained container cover;

FIG. 28 is a partially-sectioned view in side elevation of the self-adjusting, counter-rotating blade assembly disposed within a container during shaving and mixing; and

FIG. 29 is an amplified, partially-sectioned view in side elevation of the self-adjusting, counter-rotating blade assembly disposed within a container during shaving and mixing.

### DETAILED DESCRIPTION OF PREFERRED EMBODIMENTS

The in-cup shaving and blending system with a self-adjusting, counter-rotating blade assembly disclosed herein is subject to a wide variety of embodiments. However, to ensure that one skilled in the art will be able to understand and, in appropriate cases, practice the present invention, certain preferred embodiments of the broader invention revealed herein are described below and shown in the accompanying drawing figures.

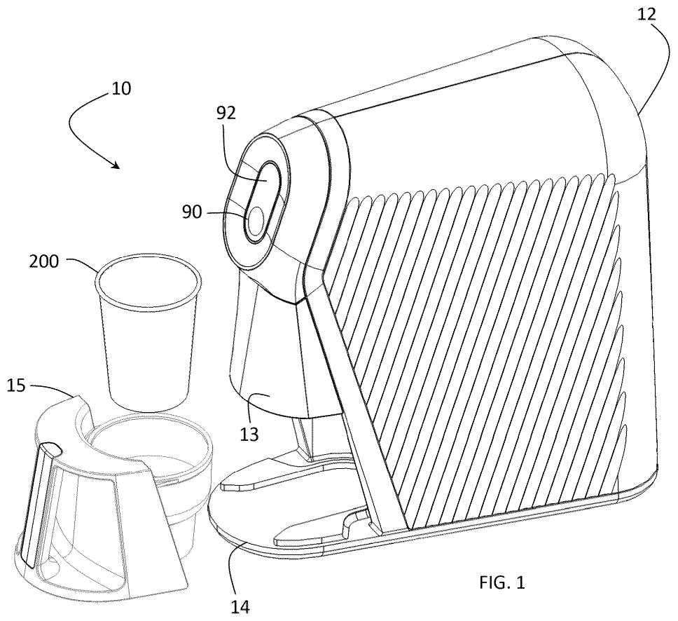

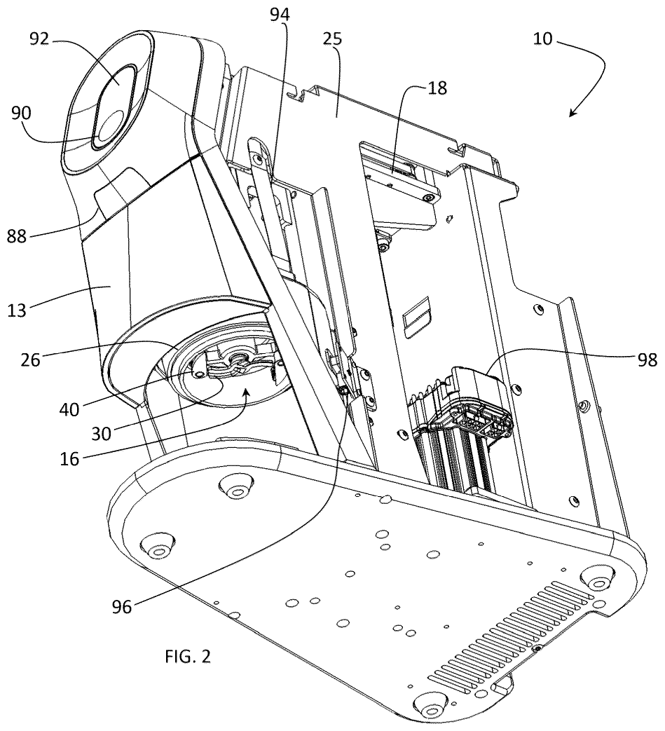

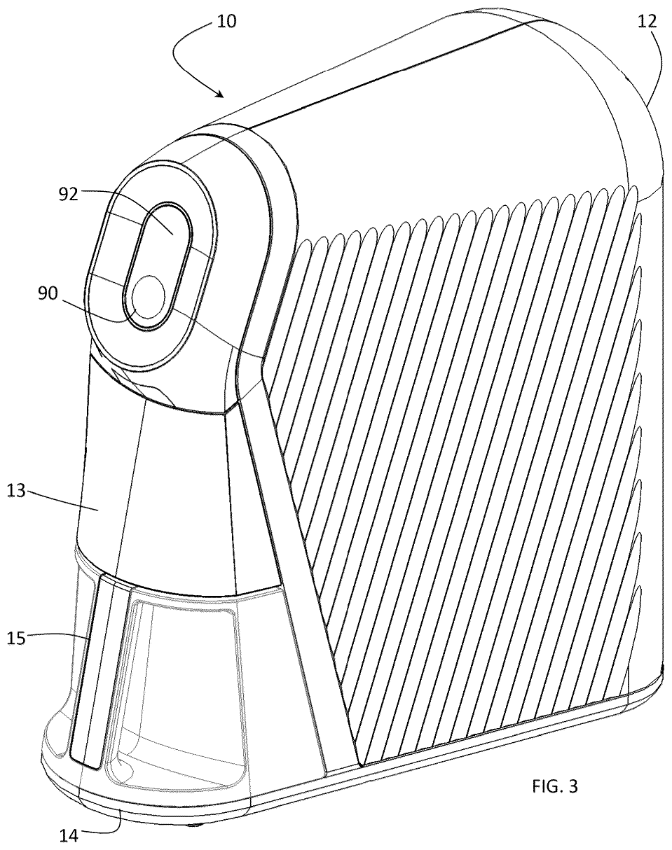

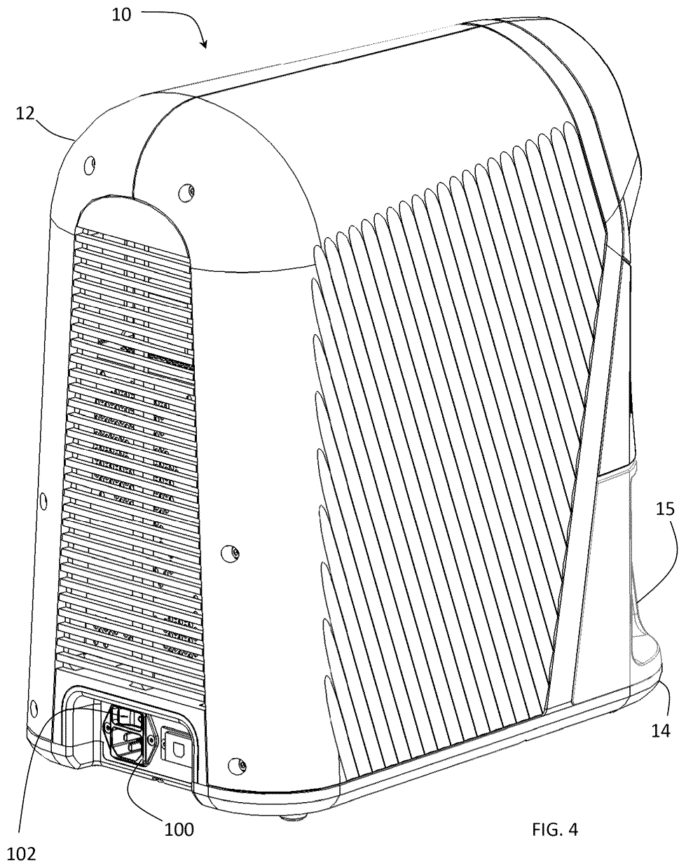

With more particular reference to the drawings, an in-cup shaving and blending system with a self-adjusting, counter-rotating blade assembly according to the present invention is indicated generally at 10 in FIGS. 1 through 4. There, the shaving and blending system 10 can be seen to have a frame structure 25 that is encased by a system casing 12 and an anterior shell portion 13. A container support platform 14 defines a shelf for selectively receiving and retaining a container support structure 15. As seen in FIG. 2, for instance, a self-adjusting, counter-rotating shaving and blending blade assembly 16 is retained relative to the frame structure 25 for extension and retraction in relation to the container support platform 14 and thus in relation to a container 200 retained by a container support structure 15 received and retained atop the container support platform 14 to shave and blend the frozen mix contents of the container 200 as is shown and described further herein.

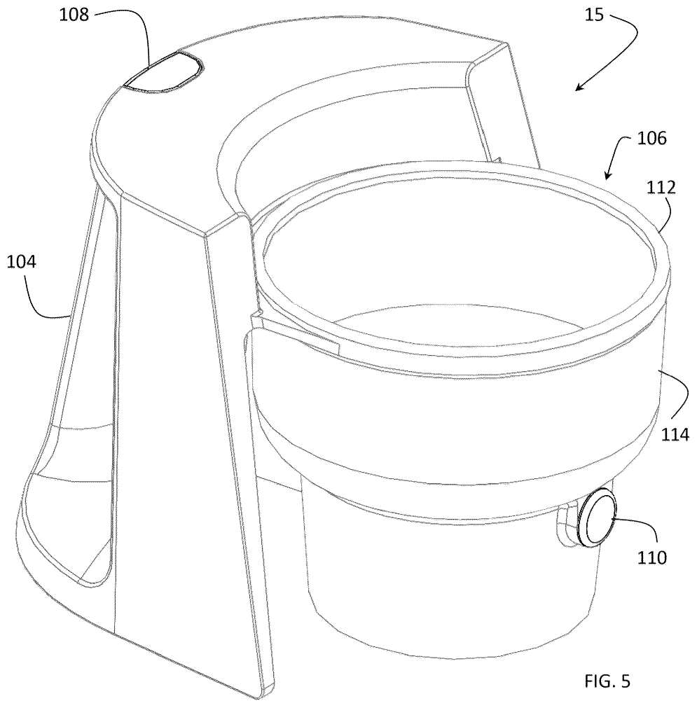

As FIG. 5 illustrates, the container support structure 15 of the present embodiment has a handle structure 104 that retains a retaining cup 106 with an annular sidewall 114 and an upper rim 112. The retaining cup 106 defines an inner volume for receiving a container 200 that itself retains contents, such as frozen contents, to be shaved and blended. The retaining cup 106 has a base portion adapted to receive a base portion of a cup 200 or other container 200 in a snug relationship, and the upper rim 112 of the retainer cup 106 has a diameter greater than the diameter of the container 200 to be received.

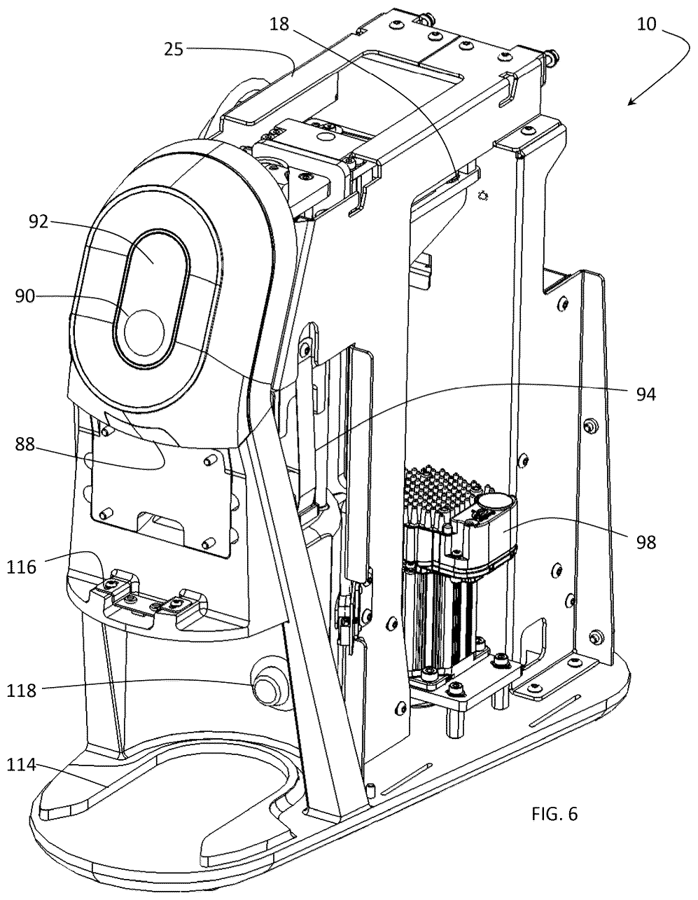

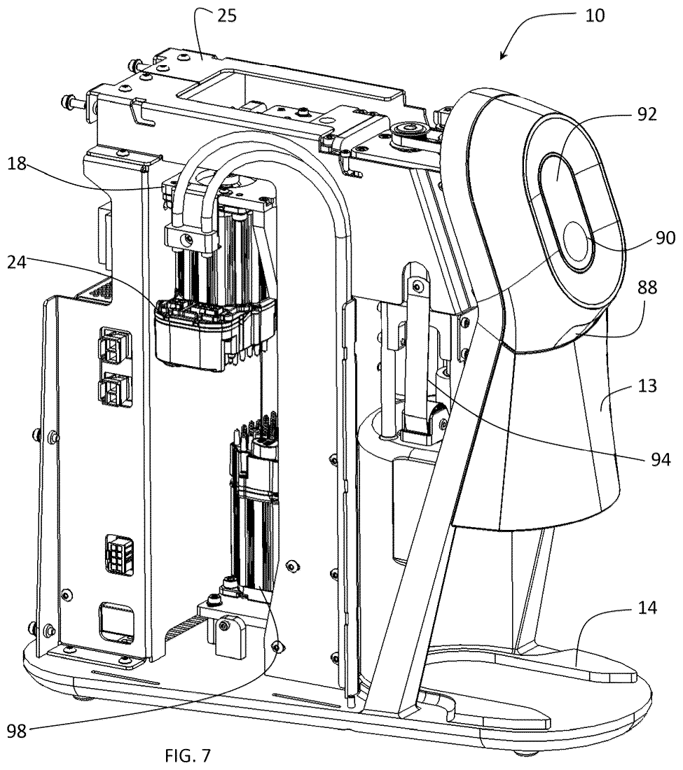

A sensor magnet 108 is retained by the container support structure 15 proximal to the handle 104, such as along an upper edge of the container support structure 15. As shown and described herein, the sensor magnet 108 is operative to enable a sensing by a support structure sensor 116 as shown in FIG. 6, for instance, of whether the container support structure 15 is fully received by the container support platform 14 and, as a consequence thereof, whether the shaving and blending system 10 can be safely operated. When the container support structure 15 is detected by the support structure sensor 116 as being fully inserted, operation of the shaving and blending system 10 can be electronically permitted. When the container support structure 15 is not detected by the support structure sensor 116 as being fully inserted, operation of the shaving and blending system 10 can be electronically prevented.

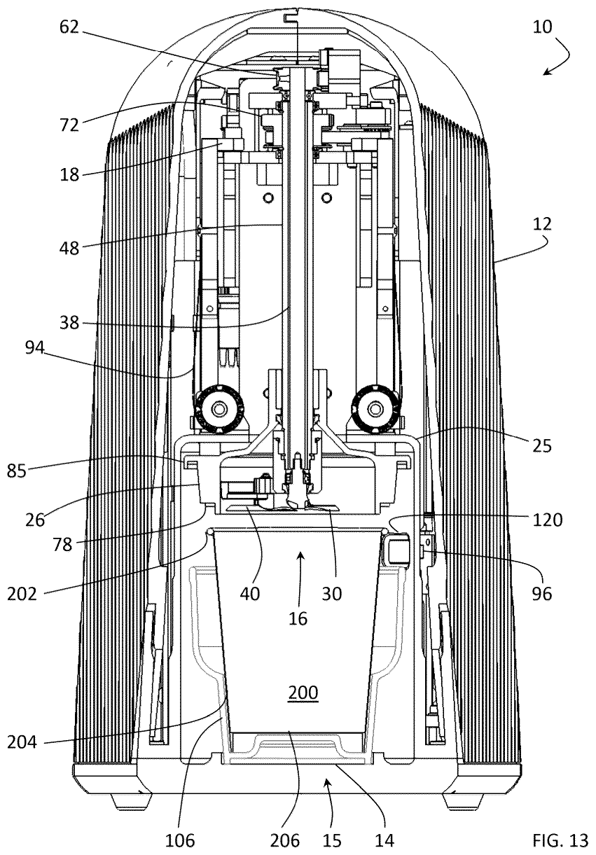

Further, with reference to FIGS. 2 and 13, a cup sensor 96, such as a reflective or other sensor 96, is retained in relation to the frame structure 25. The cup sensor 96 has a view to the space in which the container support structure 15 is received atop the container support platform 14 through a sensor window 120 in the casing surrounding the container support platform 14. The cup sensor 96 is operative to detect whether a container 200 is in place within the container support structure 15 when the support structure 15 is received atop the container support platform 14. By operation of computer software operating on electronic circuitry of the shaving and blending system 10, a shaving and blending operation can be permitted only where a container 200 is detected to be in place within the container support structure 15 by the cup sensor 96 and the container support structure 15 is detected to be in place atop the container support platform 14 by the container support sensor 116. Also by operation of computer software operating on electronic circuitry of the shaving and blending system 10, a cleaning operation in which the blade assembly 16 is rotated within a cleaning solution disposed within the retaining cup 106 of the container support structure 15 can be permitted only where a container 200 is not detected to be in place within the container support structure 15 by the cup sensor 96 but the container support structure 15 is detected by the container support sensor 116 to be in place atop the container support platform 14.

A retaining magnet 110 is retained by the container support structure 15 distal to the handle 104, such as exterior to the distal surface of the sidewall 114 opposite the handle 104. The retaining magnet 110 is positioned to align with and be attracted by a retaining magnet 118 fixed in relation to the frame structure 25. The container support structure 15, with or without a container 200, can thus be selectively retained in place relative to the frame structure 25 in proper alignment with the shaving and blending assembly 16.

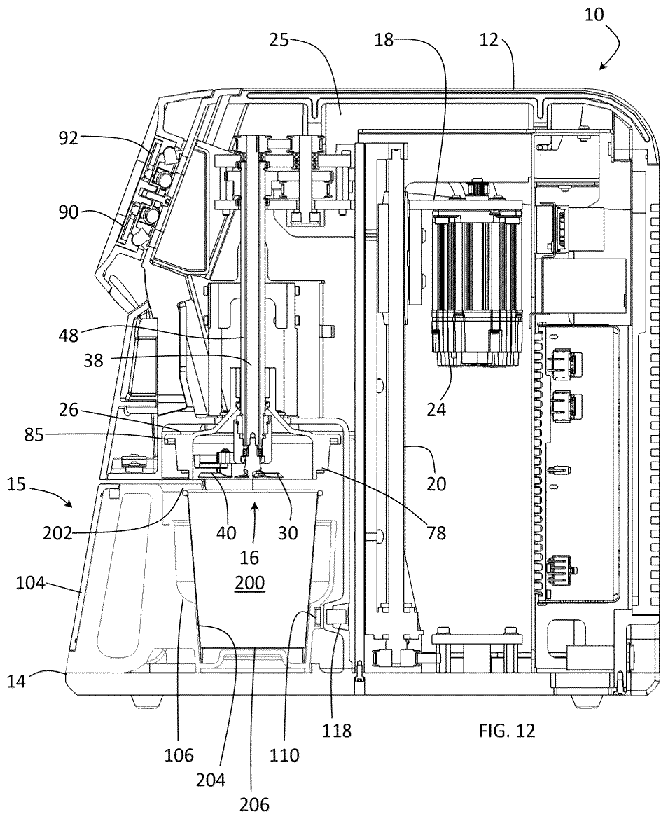

With additional reference to FIGS. 12 through 19, the shaving and blending assembly 16 is retained by a shaft assembly formed by inner and outer rotatable shafts 38 and 48. The inner and outer shafts 38 and 48 and thus the shaving and blending assembly 16 are retained for extension and retraction in relation to the frame structure 25 and in relation to the container support structure 15 and a retained container 200. Extension of the shaft assembly is operative to lower the shaving and blending assembly 16 into the container support structure 15 and a retained container 200, such as to enable a progressive shaving and blending of the frozen mix contents of a container 200 retained by the container support structure 15. Retraction of the shaft assembly is operative to raise the shaving and blending assembly in relation to the container support structure 15, such as to enable a further blending of the shaved contents of the container 200 as is shown and described further herein.

In the present embodiment, the shaft assembly formed by the inner and outer shafts 38 and 48 is supported by a mobile stage 18. The mobile stage 18 is selectively raised and lowered along rails 20 by operation of a vertical actuation motor 98 thereby to extend and retract the shafts 38 and 48 and the shaving and blending assembly 16 in relation to the container support platform 14 and in relation to a retained container 200. It will be understood, however, that the shaving and blending assembly 16 could be otherwise extended and retracted within the scope of the invention.

In this non-limiting example, the container 200 comprises a cup 200, which could comprise a simple paper cup 200, but it will be understood that other containers 200 are within the scope of the invention except as it may be expressly limited by the claims. The container 200 has a rim 202, a sidewall 204, and a bottom 206. The container 200 is round, and the sidewall 204 has an inner diameter that progressively diminishes from the rim 202 to the bottom 206 to establish a frusto-conical inner volume. Where the container 200 comprises a paper cup 200, the sidewall 204 may comprise a wrapped sleeve with an overlapping portion that, as is common to the art, has inner and outer stepped edges communicating longitudinally therealong.

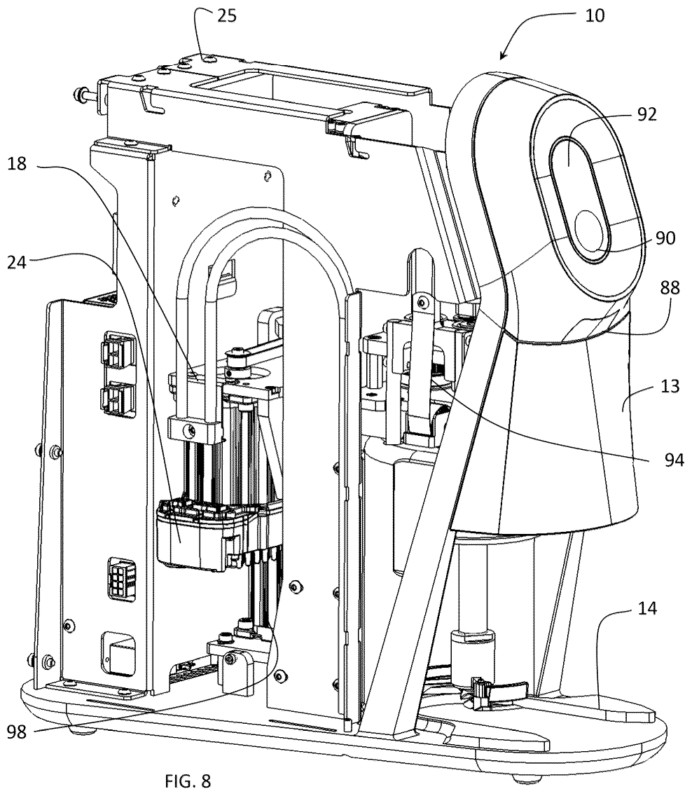

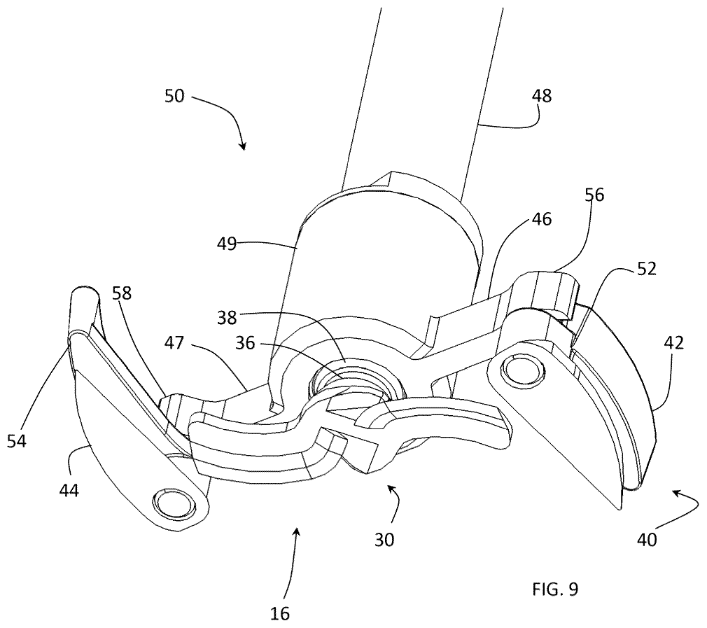

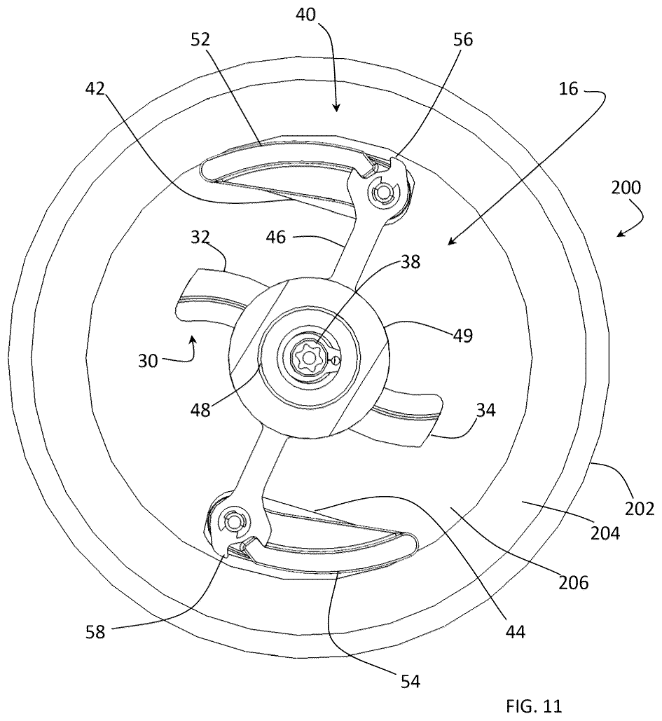

With additional reference to FIGS. 9 through 11, for example, the shaving and blending assembly 16 can be seen to incorporate counter-rotating inner and outer blade subassemblies 30 and 40. The inner blade subassembly 30 has first and second shaving blades 32 and 34 fixedly retained to project laterally outwardly from a central hub 36. The central hub 36 and the first and second blades 32 and 34 are rotatable by operation of an inner shaft 38.

The outer blade subassembly 40 likewise has first and second shaving blades 42 and 44. The first and second blades 42 and 44 of the outer blade assembly 40 are retained laterally outward of the blades 32 and 34 of the inner blade subassembly 30 by first and second arms 46 and 47 that project in radially opposite directions from a central hub 49, which in the depicted embodiment is fixed to a distal portion of the outer shaft 48. The outer shaft 48 is tubular, and the inner shaft 38 is received concentrically within the outer shaft 48.

The inner and outer shafts 38 and 48 are independently rotatable. Under this configuration, the inner shaft 38 and thus the first and second blades 32 and 34 of the inner blade subassembly 30 can be rotated in a first rotational direction, such as clockwise. Simultaneously, the outer shaft 48 and thus the first and second arms 46 and 47 and the first and second blades 42 and 44 of the outer blade subassembly 40 can be rotated in a second, opposite rotational direction, such as counter-clockwise.

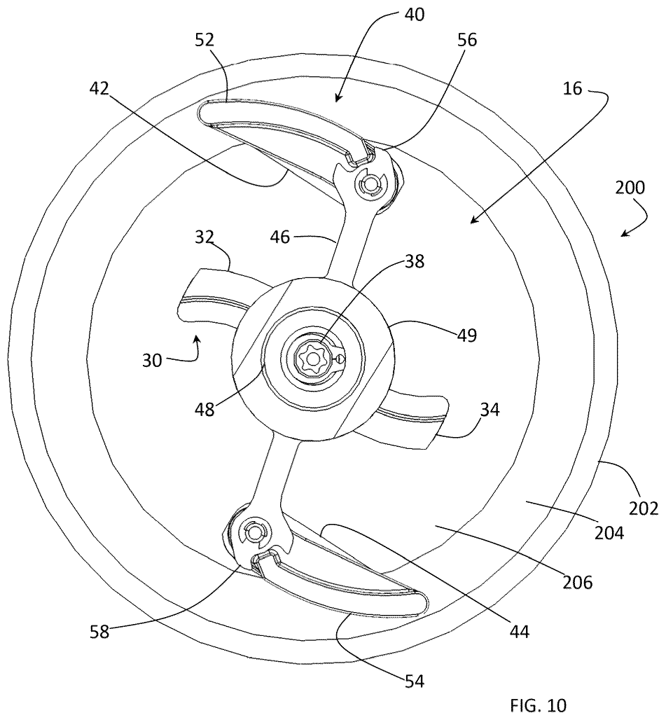

With particular reference to FIG. 10, the first and second blades 32 and 34 of the inner blade subassembly 30, which are fixed in relation to the central hub 36, operate over an inner shaving zone Zᵢ. The first and second blades 42 and 44 of the outer blade subassembly 40, however, are pivotable about their proximal end portions in relation to the first and second arms 46 and 47 thereby establishing an adjustable outer shaving zone Zₒ. The adjustable outer shaving zone Zₒ is disposed at least partially radially outward of the inner shaving zone Zᵢ. The first and second blades 32 and 34 of the inner blade subassembly 30 are symmetrical and oppositely disposed relative to one another, and the first and second blades 42 and 44 of the outer blade subassembly 40 are likewise symmetrical and oppositely disposed relative to one another. While the inner and outer blade subassemblies 30 and 40 are each shown and described herein to comprise first and second blades 32, 34, 42, and 44, it will be understood that further or fewer blades 32, 34, 42, and 44 would be possible within the scope of the invention.

The first and second blades 32, 34 and 42, 44 of the inner and outer blade subassemblies 30 and 40 comprise what may be characterized as single facet chisel blades, each with a distal surface, a beveled proximal surface, and a shaving blade edge therebetween. The single facet chisel blades of the first and second blades 32 and 34 of the inner blade subassembly 30 are curved for optimal slicing during a shaving of the frozen contents of a cup 200 or other container 200. The distal surfaces and the shaving blade edges of the first and second blades 32 and 34 of the inner blade subassembly 30 are disposed in a common plane with the distal surfaces and the shaving blade edges of the first and second blades 42 and 44 of the outer blade subassembly 40. That common plane is perpendicular to the axis of rotation A of the inner and outer shafts 38 and 48.

The blade edges are disposed facing toward the rotational direction of travel of the respective blades 32, 34, 42, and 44. Where, as in this example, the inner blade subassembly 30 is designed for clockwise rotation, the first and second blades 32 and 34 of the inner blade subassembly 30 have blade edges facing in the clockwise direction, while the first and second blades 42 and 44 of the outer blade subassembly 40, which in this embodiment is configured to rotate in the counter-clockwise direction, have blade edges facing in the counter-clockwise direction. However, it will be understood that the inner and outer blade subassemblies 30 and 40 and thus the first and second shaving blades 32, 34, 42, and 44 thereof could be configured for opposite rotation, namely with the inner blade subassembly 30 and the first and second blades 32 and 34 thereof configured for rotation in a counter-clockwise direction and with the outer blade subassembly 40 and the first and second blades 42 and 44 thereof configured for rotation in a clockwise direction.

The first and second blades 42 and 44 of the outer blade subassembly 40 are retained to pivot about vertical pivot axes at the distal ends of the first and second arms 46 and 47 respectively. The blade edges of the first and second blades 42 and 44 are angled to travel with the blade edges at a positive angle that projects across radii emanating from the axis of rotation A of the blade subassemblies 30 and 40 when the outer blade assembly 40 is rotated counter-clockwise in this example. Stated alternatively, the blade edges of the at first and second blades 42 and 44 of the outer blade subassembly 40 are angled to travel when rotated for shaving at an outward angle relative to a radius emanating from the axis of rotation A and with the distal ends of the first and second blades 42 and 44 of the outer blade subassembly 40 disposed rotationally ahead of the proximal ends of the first and second blades 42 and 44 of the outer blade subassembly 40 whereby the frozen mix will tend to exert a force pressing the first and second blades 42 and 44 of the outer blade subassembly 40 to pivot outwardly thereby expanding an outer circumference of the outer shaving zone Zₒ. Reference herein to an outward angle should be considered to mean an obtuse angle relative to the radius emanating from the axis of rotation A. As a result, when the outer blade assembly 40 is rotated counter-clockwise, the distal ends of the elongate first and second blades 42 and 44 travel rotationally ahead of the proximal ends of the blades 42 and 44. The blade edges of the first and second blades 42 and 44 can thus be considered to define the inner surfaces of the blades 42 and 44 while the opposite edges of the first and second blades 42 and 44 can be considered to define the outer surfaces of the blades 42 and 44.

Consequently, as the outer blade assembly 40 is rotated in a counter-clockwise direction and applied to a frozen mix, the frozen mix exerts a force tending to pivot the first and second blades 42 and 44 outwardly thereby expanding the outer circumference of the outer shaving zone Zₒ. The blades 42 and 44 will then pivot outwardly until further outward pivoting of the blades 42 and 44 is prevented, such as by the wall 204 of the cup 200. Thus, when the outer blade subassembly 40 is rotated counter-clockwise with the blades 42 and 44 in contact with a frozen mix, the first and second blades 42 and 44 are automatically pivoted clockwise and outwardly from a retracted configuration toward an extended configuration.

When the outer blade assembly 40 is rotated in reverse, which in this example is a clockwise direction, the outward force on the first and second blades 42 and 44 is removed and replaced with an inward force as the blades 42 and 44 are rotationally pulled through the shaved frozen mix. The blades 42 and 44 are thus pivoted counter-clockwise away from an extended configuration and toward a retracted configuration.

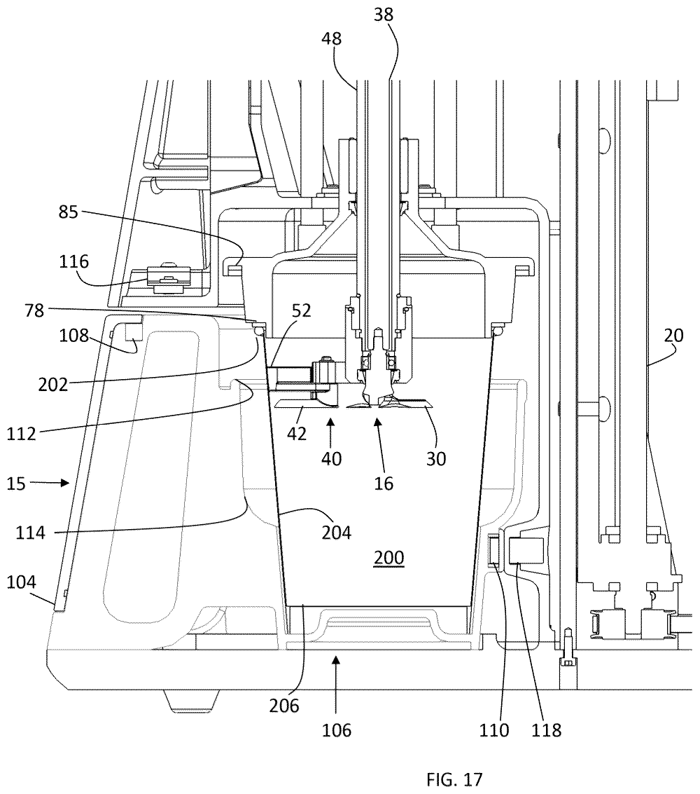

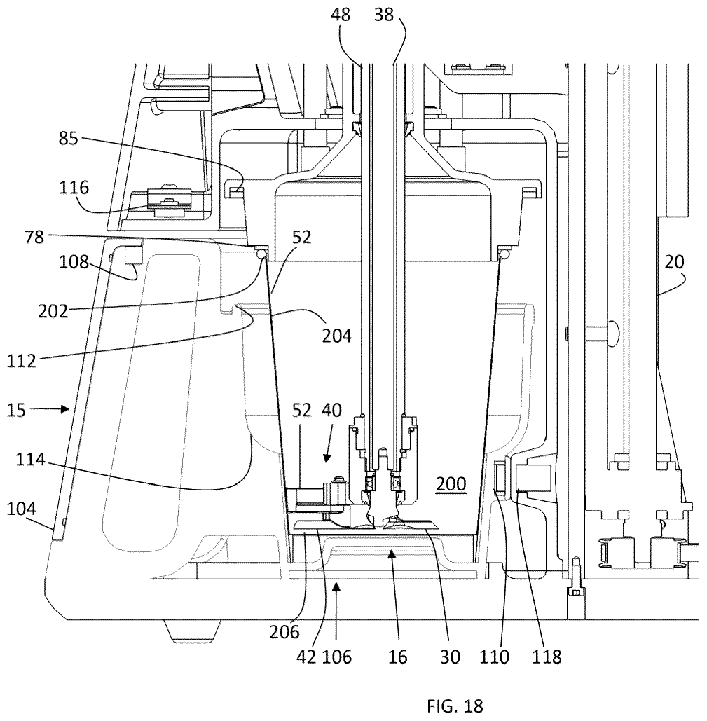

In the embodiment of FIGS. 9 through 11, the outer surfaces of the first and second blades 42 and 44 are smooth and arcuate. Accordingly, should the blades 42 and 44 make contact with the inner surface of the cup 200, the blades 42 and 44 will tend to slide along the wall 204 of the cup 200 without cutting, tearing, or other damage. However, the depicted embodiment further includes traveler members 52 and 54 that are fixed to pivot with the first and second blades 42 and 44. The traveler members 52 and 54 have outer surfaces that are broadened in a direction generally, but not exactly as described below, aligned with the longitudinal axis A. The outer surfaces of the traveler members 52 and 54 are smooth and arcuate and extend radially outward of the outer surfaces of the first and second blades 42 and 44. With that, as is perhaps best seen in FIGS. 17 and 18, the traveler members 52 and 54 will make contact with and slide along the surface of the wall 204 of the cup 200 and will tend to travel smoothly even over the inner longitudinal ridge of the wall 204 of the cup 200 where the cup 200 comprises a paper cup 200. Direct contact between the outer surfaces of the blades 42 and 44 and the wall 204 of the cup 200 is advantageously avoided.

As noted, however, the outer surfaces of the traveler members 52 and 54 are longitudinally broadened and are generally, but not exactly, aligned with the longitudinal axis A about which the shaving and blending assembly 16 rotates. Rather than communicating in parallel with the longitudinal axis A, the outer surfaces of the traveler members 52 and 54 are inwardly angled in the longitudinal direction from the proximal to the distal edges thereof to approximately match the taper of the wall 204 of a tapered cup 200. The inward angling of the outer surfaces of the traveler members 52 and 54 could, by way of illustrative example and not limitation, range between 5 and 15 degrees from their upper or proximal edges to their lower or distal edges. As such, the smooth, damage-free travel of the outer surfaces of the traveler members 52 and 54 over the wall 204 of the cup 200 is further promoted.

The first and second blades 42 and 44 have minimum inward orientations and maximum outward orientations such that excess pivoting of the first and second blades 42 and 44 inwardly and outwardly is prevented. In the present embodiment, this is accomplished by range limiting formations 56 and 58 that are operative to prevent pivoting of the first and second blades 42 and 44 of the outer blade subassembly 40 beyond a predetermined angular range in relation to the distal portions of the retaining arms 46 and 47. As perhaps best seen in FIG. 10, the range limiting formations 56 and 58 comprise alcoves in the distal portions of the retaining arms 46 and 47 in which the first and second blades 42 and 44 and traveler members 52 and 54 pivot in parallel to the axis of rotation A of the shaving and blending assembly 16. With that, the edges of the alcoves of the range limiting formations 56 and 58 prevent excess pivoting of the first and second blades 42 and 44 and the traveler members 52 and 54.

The outer diameter of the outer shaving zone Zₒ thus automatically self adjusts to the local diameter of the wall 204 of the cup 200 or other container 200 thereby permitting the shaving and blending assembly 16 to adapt to cups 200 of different sizes and to accommodate containers 200 with progressively tapered diameters as is common to paper cups. A counter-clockwise pivoting of the outer blade subassembly 40 will pivot the first and second shaving blades 42 and 44 outwardly to extended configurations to increase the circumference traveled by the distal portions of the blades 42 and 44, and a clockwise pivoting of the outer blade subassembly 40 will pivot the first and second shaving blades 42 and 44 inwardly to retracted configurations to decrease the circumference traveled by the distal portions of the blades 42 and 44. The first and second shaving blades 42 and 44 can, but need not necessarily, be biased inwardly to their retracted configurations, such by torsional springs incorporated into their pivot axes or otherwise.

In this embodiment, therefore, the outer shaving zone Zₒ established by the first and second blades 42 and 44 of the outer blade subassembly 40 has an inner diameter that is substantially fixed and an outer diameter that is adjustable to adapt automatically to different local container diameters. Meanwhile, the inner shaving zone Zᵢ in this example of the invention is fixed in outer diameter with that outer diameter being marginally smaller than the inner diameter of the outer shaving zone Zₒ established by the first and second blades 42 and 44 of the outer blade subassembly 40. With that, the inner and outer blade assemblies 30 and 40 can be rotated in opposite directions without interference therebetween while shaving a frozen mix within the container 200 over substantially the entire surface of the frozen mix.

Even with the traveler members 52 and 54, where the shaving and blending assembly 16 is used to shave and blend a frozen mix potentially in combination with a liquid within a paper cup 200 that has a sidewall 204 with a winding direction and thus a longitudinal ridge along the inner surface of the sideway 204, the direction of rotation of the outer blade subassembly 40 will preferably match the direction of winding of the cup sidewall 204 and vice versa so that the first and second blades 42 and 44 will approach the ridge from behind. Such a relationship will avoid having the distal ends of the traveler members 52 and 54 and of the first and second blades 42 and 44 from digging into the inner ridge of the sidewall 204.

Where the inner and outer blade subassemblies 30 and 40 counter-rotate as disclosed herein, the inner blade subassembly 30 will impart a rotational force on the frozen mix in a first rotational direction, in this case the clockwise direction, while the outer blade subassembly 40 will impart a rotational force on the frozen mix in a second, opposite rotational direction, in this case the counter-clockwise direction. Advantageously, despite the application of rotational forces on the frozen mix during shaving and blending, the opposite rotational forces will tend to cancel one another. The system 10 thereby presents a solution to the significant challenge of effectively shaving and blending the frozen and liquid contents of a container 200 without having those contents tend to spin within the container 200 or even having the entire container 200 spin, such as within the container support structure 15 or in any other support structure, each to the frustration of the shaving and blending process.

By control of the geometry and relative size and rotational speed of the inner and outer blade subassemblies 30 and 40 and the blades 32, 34, 42, and 44 thereof, the net rotational force on the frozen mix can be caused to approach zero. For instance, by selective calibration of the gear assembly 22 shown and described herein, the relative rotational speeds of the inner and outer blade assemblies 30 and 40 can be calibrated to cause the net rotational force on the frozen mix to be approximately nullified. Additionally or alternatively, the relative sizes and, additionally or alternatively, configurations of the blades 32, 34, 42, and 44 can be adjusted to approximate zero net rotational force. With that, the risk of undesirable spinning of the frozen mix can be eliminated with little or no reliance on other measures, such as rigid clamping and surface formations, as has typically been required of the prior art. Moreover, the shaving and blending system 10 can be operative in relation to a standard container 200, such as a simple paper cup 200, devoid of special features needed to prevent or minimize the inadvertent spinning of a retained frozen mix.

As set forth above, the inner and outer shafts 38 and 48 are longitudinally extendable and retractable and independently rotatable in relation to the frame structure 25 and in relation to the container platform 14 and a container 200 retained by the container holder 15. The rotation of the inner and outer shafts 38 and 48 is powered by a blade rotation drive motor 24, which travels with the stage 18. Raising and lowering of the stage 18 and thus extension and retraction of the inner and outer shafts 38 and 48 are powered by a vertical actuation motor 98, which is fixedly retained by the frame structure 25, such as through rack and pinion gearing, a threaded engagement, or any other method. The raising, lowering, and rotation of the shafts 38 and 48 can be manually or automatically controlled by operation of electronic software programmed into electronic memory of the system 10. Electrical power to the system 10 can be provided through, for example, a power supply cord through a power input socket 100. The initial flow of power to the system 10 is controlled by a power switch 102.

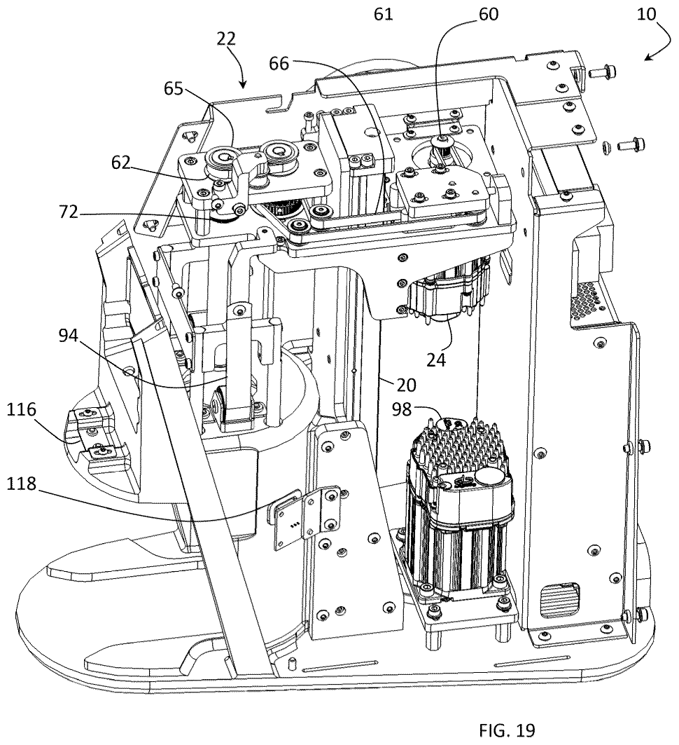

With particular reference to FIG. 19, the gear drive assembly 22 in this embodiment has an output pulley 60 that rotates with the output shaft of the motor 24. The output pulley 60 drives a belt 61 that in turn rotates a driven pulley 62 and a drive shaft 67. The drive shaft 67 in turn powers a belt 65 that is operative to rotate a driven pulley 62 that is fixed to rotate the inner shaft 38 and thus the inner blade assembly 30. The gear drive assembly 22 further establishes an opposite drive mechanism for rotating the outer shaft 48 in a rotational direction opposite that of the inner shaft 38. In this example, a gear 66 is fixed to rotate with the drive shaft 67 and to mesh with and rotate a gear 72 that is retained to rotate the outer shaft 48 and thus the outer blade assembly 40 in a direction opposite to that of the inner blade assembly 30. With this, a single motor 24 is operable to rotate the inner shaft 38 in a first rotational direction while rotating the outer shaft 48 in a second, opposite rotational direction. Moreover, the gearing drive assembly 22 can be configured to rotate the inner and outer blade subassemblies 30 and 40 at the same rotational speeds or at different speeds depending, for instance, on the desired interactions of the blade subassemblies 30 and 40 with the frozen mix.

The shaving and blending assembly 16 can be attachable and detachable relative to the inner and outer shafts 38 and 48, such as for cleaning, repair, or replacement. As shown in FIGS. 12 through 15, for instance, the inner and outer shafts 38 and 48 can together form a sealed shaft assembly 50. The distal ends of the inner and outer shafts 38 and 48 have selective engaging portions for selectively coupling to engaging portions of the shaving and blending assembly 16. Any effective engaging portions are within the scope of the invention except as expressly excluded by the claims. For instance, the engaging portions can comprise keyed projections and correspondingly keyed reception cavities, ball and detent combinations, retaining pins, mechanical fasteners, interference fits, intermeshing structures, or any other operative engaging portion. With this, the shaving and blending assembly 16 and the shafts 38 and 48 can be readily disconnected and reconnected, such as for cleaning, repair, or replacement.

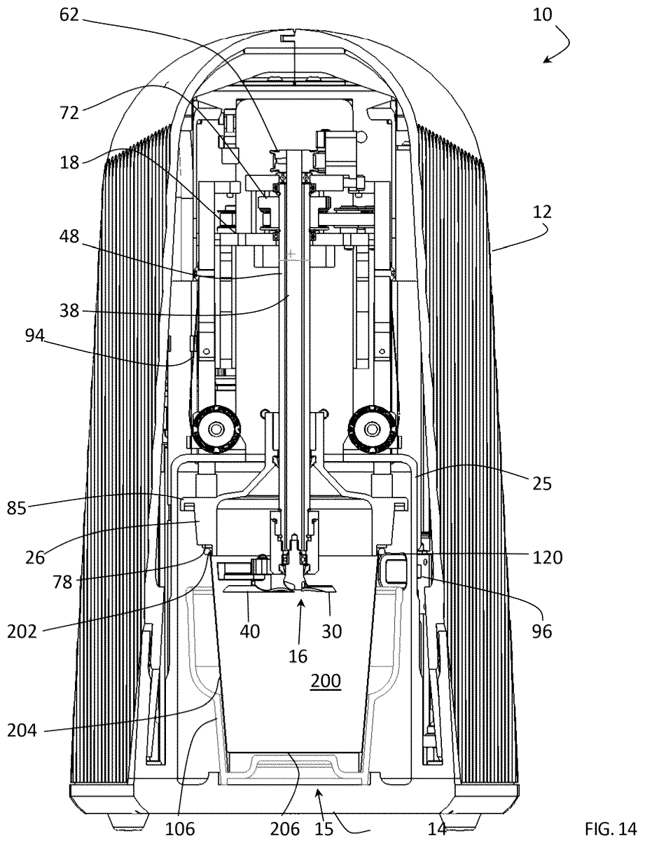

With further reference to FIGS. 12 through 15, a bonnet cover 26 is concentrically retained by the shaft assembly formed by the inner and outer shafts 38 and 48. The shafts 38 and 48 pass through a central opening in a top of the bonnet cover 26. The central opening is sized to receive the shafts 38 and 48 closely but with free relative rotary and longitudinal movement between the cover 26 and the shafts 38 and 48. The bonnet cover 26 itself is retained against rotation and is biased to an extended position by constant force springs 94 supported by a bonnet support bracket 95 as shown, for instance, in FIGS. 13 and 14. The bonnet cover 26 can be considered to have an annular dome shape. As FIG. 2 illustrates, the shaving and blending assembly 16 is stowed inside the bonnet 26 when not in use for safety.

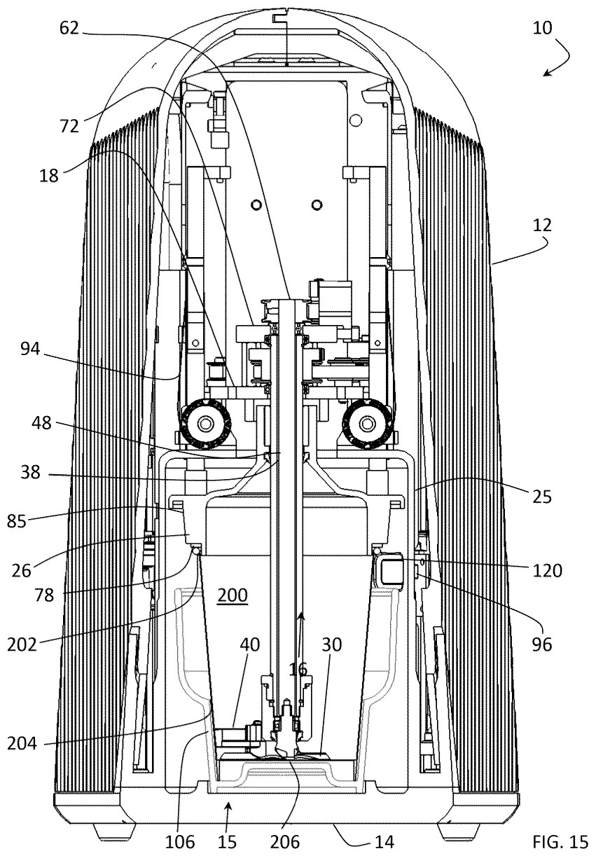

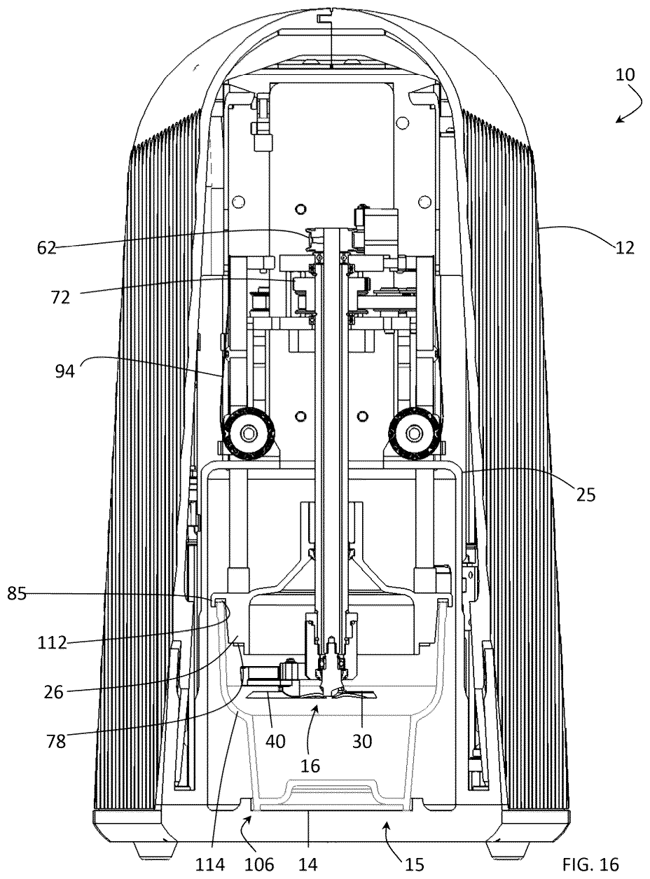

The bonnet cover 26 has a distally disposed cup sealing ring 78 and a proximally disposed container holder sealing ring 85. The cup sealing ring 78 comprises a stepped shoulder sized to sealingly engage a rim 202 of a cup 200 or other container 200 as shown, for instance, in FIGS. 14 and 15. Each sealing ring 78 and 85 can include an O-ring for ensuring sealing engagement. When engaged with the rim 202 of the container 200, the cup sealing ring 78 of the bonnet cover 26 thus establishes a substantially enclosed volume defined by the wall 204 and the bottom 206 of the container 200 and the peripheral wall and top of the bonnet cover 26. The container holder sealing ring 85 comprises an annular ring that extends outwardly of the body of the bonnet cover 26 that is sized to sealingly engage the rim 112 of the container holder 15 as is shown, for instance, in FIG. 16. When engaged with the rim 112 of the container holder 15, the container holder sealing ring 85 thus establishes a substantially enclosed volume defined by the sidewall 114 and bottom of the cup 106 of the container holder 15 and the top of the bonnet cover 26.

Since the retaining cup 106 defines an inner volume for receiving the container 200, the upper rim 112 of the retainer cup 106 of the container holder 15 has a diameter greater than the diameter of the upper rim 202 of the cup 200 or other container 200 that is to be received. Accordingly, the container holder sealing ring 85 of the bonnet cover 85, which has a diameter sized to sealingly engage the upper rim of the retainer cup 106, has a greater diameter than the diameter of the cup sealing ring 78 of the bonnet cover 26. When the container holder sealing ring 85 of the bonnet cover 26 is engaged with the upper rim of the retainer cup 106 of the container holder 15 without a container 200 received therein, the cup sealing ring 78 of the bonnet cover 26 is thus also enveloped within the enclosed inner volume defined between the bonnet cover 26 and the retainer cup 106 of the container holder 15 thereby facilitating cleaning thereof during the cleaning operation shown and described herein.

Under such constructions, with a container 200 retained by the container holder 15 and the container holder 15 received atop the container platform 14 to bring the container 200 into concentric alignment with the inner and outer shafts 38 and 48, the shaving and blending assembly 16 and the bonnet cover 26 can be extended into engagement with the container 200 by a lowering of the stage 18 with the inner and outer shafts 38 and 48 and the shaving and blending assembly 16 retained thereby. When lowered into place, the bonnet cover 26 enshrouds the container 200 to permit shaving and blending without a risk of spillage or mess. Once shaving and blending are complete, the bonnet cover 26 and the shaving and blending assembly 16 can be withdrawn from the container 200. Moreover, where a container 200 is not retained by the container holder 15 and the container holder 15 is received atop the container platform 14, the shaving and blending assembly 16 and the bonnet cover 26 can be extended into engagement with the container holder 15 so that the bonnet cover 26 enshrouds the cup 106 of the container holder 15 to permit a blade cleaning operation again without a risk of spillage or mess. Once the cleaning process is complete, the bonnet cover 26 and the shaving and blending assembly 16 can be withdrawn from the cup 106 of the container holder 15.

In practices of the invention, the shaving and blending process can be selectively initiated by a user, such as by a pressing of a run button 90. Furthermore, the blade cleaning process can be selectively initiated by a user by a pressing of a clean button 92. It is also within the scope of the invention for either or both processes to be completely or partially initiated automatically by the shaving and blending system 10, such as upon reception of the container holder 15 atop the container platform 14 based on a detection or lack of detection of a container 200 retained by the container holder 15. Again, by operation of computer software operating on electronic circuitry of the shaving and blending system 10, the shaving and blending operation can be permitted only where a container 200 is detected to be in place within the container support structure 15 by the cup sensor 96 and the container support structure 15 is detected to be in place atop the container support platform 14 by the container support sensor 116.

Similarly, the cleaning operation during which the blade assembly 16 is rotated within a cleaning solution disposed within the retaining cup 106 of the container support structure 15 can be permitted only where a container 200 is not detected to be in place within the container support structure 15 by the cup sensor 96 but the container support structure 15 is detected to be in place atop the container support platform 14. During the cleaning operation, the blade subassemblies 30 and 40 can be rotated in directions opposite to their respective shaving rotational directions to ensure a full cleaning not only of the blades 32, 34, 42, and 44 but also of the bonnet cover 26 and the cup sealing ring 78.

With the shaving and blending system 10 so constructed, a frozen mix and potentially an added liquid retained within a container 200 can be smoothly, quietly, and completely shaved and blended as can be understood with reference, for example, to FIGS. 13 through 15. In an initial step, a cup 200 or other container 200 is disposed in the cup 106 of the container support structure 15 and the container support structure 15 is inserted atop the support platform 14 in concentric alignment with the inner and outer shafts 38 and 48. The shaving and blending assembly 16 can then be induced into operation, such as by actuation of the run button 90 on the control panel, by remote or other control, automatically, or by some combination thereof.

When the shaving and blending assembly 16 is induced into operation, the inner and outer shafts 38 and 48 and the retained shaving and blending assembly 16 and bonnet cover 26 can be extended by motorized operation of the system 10. Through the extension of the shafts 38 and 48, the shaving and blending assembly 16 and the bonnet cover 26 are advanced into engagement with the cup 200 until the cup sealing ring 78 of the bonnet cover 26 receives and engages the rim 202 of the cup 200 to enshroud the inner volume of the cup 200. Then, the inner and outer shafts 38 and 48 can be induced into counter-rotation with the inner shaft 38 in this embodiment being rotated in a clockwise manner while the outer shaft 48 is rotated in a counter-clockwise manner.

With sufficient further extension of the shafts 38 and 48, the blades 32, 34, 42, and 44 of the inner and outer blade subassemblies 30 and 40, based on their coplanar, concentric relationship, will make simultaneous contact with any retained liquid and ultimately the frozen mix. Once in contact with the frozen mix, the clockwise rotating inner blade subassembly 30 will begin shaving frozen mix over the inner shaving zone Zᵢ. Simultaneously, rotating counter-clockwise, the outer blade subassembly 40 will begin shaving frozen mix over the annular outer shaving zone Zₒ surrounding the inner shaving zone Zᵢ. The blades 42 and 44 of the outer blade assembly 40 will automatically pivot to match the local inner diameter of the wall 204 of the cup 200.

As the inner and outer blade assemblies 30 and 40 are counter-rotated, they are advanced longitudinally into the frozen mix. The blade assemblies 30 and 40 thereby shave away successive layers of frozen mix at a layer depth controlled by the rotational speed and rate of longitudinal advancement of the inner and outer shafts 38 and 48. As the inner and outer blade subassemblies 30 and 40 delve deeper into the frozen mix, a controlled layer depth is shaved with each rotation thereby yielding a smooth and consistent texture of the shaved mix. Moreover, by shaving such a controlled depth, the shaving and blending assembly 16 can work effectively at a slower rotational speed than, for instance, a prior art blender to permit smoother and quieter operation.

In one non-limiting example, an embodiment of the shaving and blending system 10 is operative to rotate the inner and outer blade subassemblies 30 and 40 at matching rates of approximately 63.5 rotations per minute while progressively advancing the subassemblies 30 and 40 longitudinally at a rate of 0.5 millimeters per second. Under that operational format, the blades 32, 34, 42, and 44 shave away approximately 0.24 millimeters (0.010 inches) of the frozen mix per rotation. While the foregoing rotational and longitudinal advancement speeds have been found to be advantageous, other speeds are, of course, possible and within the scope of the invention except as the claims may be expressly limited.

According to embodiments of the system 10, motor torque can be monitored. The rotational speed of either or both blade assemblies 30 and 40 and the rate of longitudinal advancement can be automatically adjusted, such as by computer software operative within the system 10, based on sensed motor torque, resistance, or other factors. Such embodiments can thereby optimize the overall shaving and blending time while nonetheless producing a product of the desired shaving and blending characteristics. Moreover, system wear and the risk of damage to the shaving and blending assembly 16 and the system 10 in general can be minimized.

As the blades 42 and 44 of the self-adjusting outer blade assembly 40 shave the frozen mix, a constant outward force applied by the frozen mix presses the blades 42 and 44 outwardly thereby automatically adjusting the blades 42 and 44 in an outward lateral direction until further outward movement is restricted, such as by the outer surfaces of the blades 42 and 44 or the traveler members 52 and 54 making contact with the sidewall 204 of the cup 200 as FIGS. 17 and 18 show perhaps most clearly. As the shaving and blending assembly 16 is further advanced into the frusto-conical inner volume of the cup 200, the self-adjusting nature of the outer blade assembly 40 permits an automatic, progressive adaptation of the outer diameter effectively traversed by the distal ends of the first and second blades 42 and 44 of the outer blade assembly 40 while the inner ends of the first and second blades 42 and 44 travel along a substantially consistent inner diameter.

The outer shaving zone Zₒ is thus continuously adjustable. With a tapered cup 200 as illustrated, the narrowing outer wall 204 of the cup 200 will guide the traveler members 52 and 54 and thus the blades 42 and 44 to a progressively narrowed configuration in an automatic adaptation to the local diameter of the cup 200. With the automatically adjusting nature of the outer blade assembly 40 and with the coverage of the central portion of the frozen mix provided by the inner blade assembly 30, the entirety of the frozen mix both laterally across the cup 200 and from top to bottom can be shaved. As a consequence, icy chunks and other solid portions are minimized or eliminated. Moreover, to the extent necessary, the shaving and blending assembly 16 can automatically adjust to cups 200 and other containers 200 of varying diameters, tapers, and other characteristics.

For avoidance of doubt, while the interaction between the first and second blades 42 and 44 of the outer blade assembly 40 to induce extension and retraction of the blades 42 and 44 is advantageous, it is within the scope of the invention for the blades 42 and 44 to be extended and retracted by other or additional mechanisms and methods except as the claims may expressly exclude. For instance, embodiments of the shaving and blending assembly 10 could additionally or alternatively incorporate biasing or actuation members or devices, such as springs, or other mechanical, electro-mechanical, or other features to cause the first and second blades 42 to extend and retract to accommodate the local diameter of the container 200. In certain contemplated embodiments, for example, the first and second blades 42 and 44 could incorporate spring mechanisms or drag structural features, such as on the undersides thereof, to induce radially outward and inward movement of the blades 42 and 44 during rotation.

Once the shaving process is complete, such as when the shaving and blending assembly 16 reaches the bottom 206 of the cup 200 or is within a predetermined distance thereof, further advancement of the shafts 38 and 48 is terminated and rotation of the shafts 38 and 48 is ceased. Then, the rotations of the shafts 38 and 48 can be reversed, and the shafts 38 and 48 and the shaving and blending assembly 16 can be progressively retracted toward a raised position. As the rotation of the outer shaft 48 is reversed, in this case to the counter-clockwise direction, the self-adjusting outer blade assembly 40 will automatically self-adjust toward a retracted configuration as the first and second blades 42 and 44 are then pulled through the shaven frozen mix and any retained liquid with their distal ends rotationally trailing their proximal ends such that the shaven frozen mix applies a contractive force to the blades 42 and 44.

As the shafts 38 and 48 and the shaving and blending assembly 16 are rotated and retracted, the shaved mix and any added liquid are smoothly blended. When the shaving and blending assembly 16 has risen above the now shaved and blended mix, but potentially while the shaving and blending assembly 16 remains below the upper edge of the rim 202 of the cup 200 or at least while enshrouded by the bonnet cover 26, the shafts 38 and 48 and the inner and outer blade subassemblies 30 and 40 can be rapidly spun to clear all remaining mix from the blade subassemblies 30 and 40 and to deposit the same within the cup 200. Then, the shafts 38 and 48 and the shaving and blending assembly 16 can be adjusted to a retracted position. The cup 200 can then be removed from the retention assembly 16, and the now shaved and blended mix within the cup 200 can be enjoyed.

The operation of the shaving and blending system 10, including the rotation of the shafts 38 and 48 and the shaving and blending assembly 16 and the longitudinal extension and retraction thereof, can be initiated and controlled manually, automatically, or by combined manual and automatic control. In embodiments of the shaving and blending system 10, dedicated shaving and blending software is retained in electronic memory, such as by the framework 25, remotely, or in a combination thereof, to operate on an electronic system processor. Initial shaving and blending operation of the system 10 can, in certain practices, be triggered by manual input to a system control panel, such as through actuation of the run button 90. A user may be enabled to select varied mixing characteristics, such as mixing speed, mixing time, or other characteristics, potentially with options based on the material of the frozen mix. Once programmed and initiated, the shaving and blending system 10 can operate automatically by control of the system software to rotate and counter-rotate and to extend and retract the shafts 38 and 48 and the inner and outer blade subassemblies 30 and 40.

The container 200 can be dedicated to usage with the shaving and blending system 10, or it could be a pre-existing container 200, such as a simple recyclable paper cup 200. Dedicated containers 200 according to the present invention could be distributed and stored with a frozen mix therein for mixing and blending according to the present invention. The frozen mix can be a frozen colloidal suspension. As taught herein, the suspension can be prepared by use of a colloidal mill, a puree machine, or any other effective pre-processing machine. The apparatus can permit an adjustment of the resulting particle size in the suspension. Where fruits or vegetables are employed, they can thus be pre-ground and reduced in particle size under the operation and control of the pre-processing machine. A suspension can be created that is colloidal but not homogenized to provide a desired texture. According to practices of the invention, the micron size of the particles in the frozen mix can be set and predetermined in pre-processing for smaller particulate size.

As such, the benefits of industrial processing machinery and the resulting reduced particle size can effectively be brought into the consumer environment. In a marked advantage over home blending according to the prior art, the reduced, consistent particle size in the frozen suspension can be exploited to yield improved taste and texture, reduced sedimentation and separation, potentially improved viscosity and stability, and even an improved depth of the color of the resulting shaved and blended mix.

According to certain practices of the invention, as FIG. 1 shows, each container 200 can have an identifier 86 thereon or therein. The identifier 86 could be unique to the individual container 200. Alternatively or additionally, series, types, or groups of containers 200 can have series, type, or group identifiers 86. The identifiers 86 can, by way of example and not limitation, be two-dimensional codes, such as numerical, bar, or quick response (QR) codes. Additionally or alternatively, the identifiers 86 could comprise electronic identifiers, such as but not limited to radiofrequency identification (RFID) micro chips or other electronic identifiers. As FIG. 1 also illustrates, the shaving and blending system 10 can incorporate a reader 88 for detecting the identifier 86 and, through the identifier 86, the container 200 and, potentially, the frozen mix contained in the container 200.

The shaving and blending system 10 can be operative based on the detected identifier 86. For instance, the shaving and blending system 10 can be programmed by computer software to perform a shaving and blending operation dependent on the detected frozen mix within the container 200 as indicated by the identifier 86. Moreover, within the scope of the invention, embodiments of the system 10 can be inoperable by the system computer software in relation to containers 200 not bearing an identifier 86 authenticated by the reader 88. Still further, the system 10 can be programmed by computer software to shave and blend the contents of a given identified container 200 only once to prevent potentially contaminated or dangerous reuse of containers 200 with foreign content that may not be suitable to shaving and blending with the shaving and blending system 10.

In certain embodiments, the identifier 86 for the container 200 can comprise a bar code, a QR code, or another pattern that may be printed or otherwise applied or retained. The identifier 86 can, for instance, trigger computer software programmed to induce the shaving and blending system 10 to rotate and advance the inner and outer blade subassemblies 30 and 40 of the shaving and blending assembly 16 at desired rotational speeds and at a desired rate of longitudinal advancement during shaving of a frozen mix and potentially at desired rotational speeds and longitudinal retraction during blending. Such authenticated containers 200 thus enable the system 10 to be calibrated to match finished drink requirements. Drink recipes will vary, and the ability of the system 10 to adjust in shaving and blending characteristics can be calibrated to maximize ingredient attributes. For instance, the system 10 can be calibrated by computer software to blend a dairy-base smoothie or shake more thoroughly than a margarita.

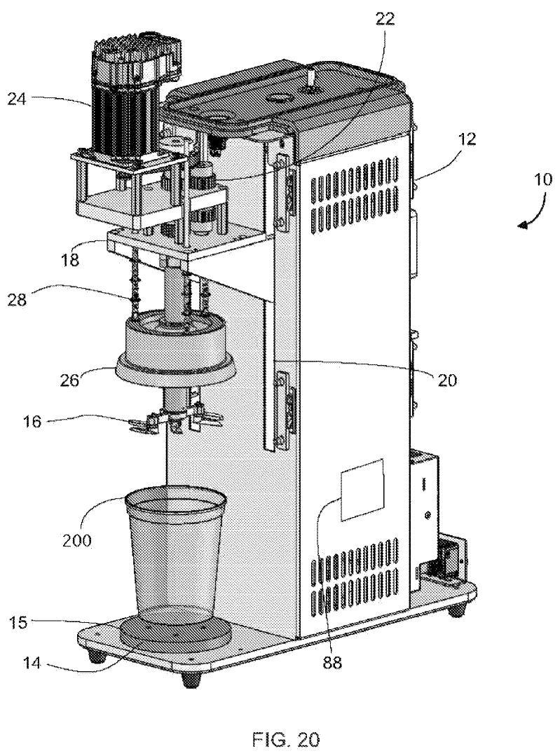

An alternative embodiment of the in-cup shaving and blending system with a self-adjusting, counter-rotating blade assembly according to the present invention is again indicated generally at 10 in FIG. 20. There, the shaving and blending system 10 can be considered to be founded on a system housing or framework 12. A container platform 14 extends from a lower portion of the system housing 12 and a stage or support structure 18 extends from an upper portion of the system housing 12 to overhang the container platform 14. The container platform 14 incorporates a retention assembly 15, alternatively referred to as a container holder 15, which can vary within the scope of the invention.

A self-adjusting, counter-rotating shaving and blending assembly 16 is retained by the support structure 18 for raising and lowering relative to the system housing 12 and in relation to the platform 14 to selectively engage a retained container 200 and to shave and blend the frozen mix contents thereof as is shown and described further herein. In the present embodiment, the support structure 18 is selectively raised and lowered along rails 20 in relation to the platform 14 thereby to extend and retract the shaving and blending assembly 16 in relation to the platform 14 and in relation to a retained container 200. It will be understood, however, that the shaving and blending assembly 16 could be otherwise extended and retracted within the scope of the invention.

In the depicted embodiment, the retention assembly 15 comprises a retention plate 15 with a receiving indentation for selectively retaining a container 200 atop the platform 14. Again, however, further or different retention assemblies 15 are possible and within the scope of the invention except as expressly excluded by the claims. In other non-limiting embodiments, for example, the retention assembly 15 can additionally or alternatively comprise a clamping assembly or any other structure capable of selectively retaining a container 200 atop the platform 14.

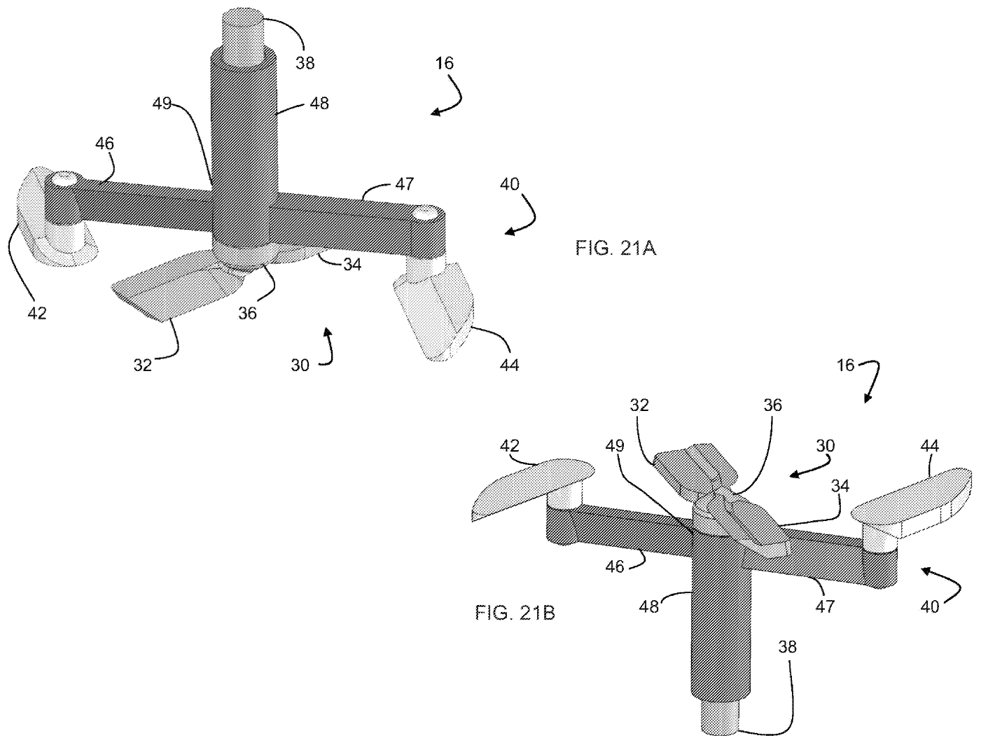

With additional reference to FIGS. 21A through 23B, the shaving and blending assembly 16 can be seen to again incorporate counter-rotating inner and outer blade subassemblies 30 and 40. The inner blade subassembly 30 has first and second shaving blades 32 and 34 that are fixedly retained to project laterally outwardly from a central hub 36. The central hub 36 and the first and second blades 32 and 34 are rotatable by operation of an inner shaft 38. The outer blade subassembly 40 likewise has first and second shaving blades 42 and 44. The first and second blades 42 and 44 of the outer blade assembly 40 are retained laterally outwardly of the blades 32 and 34 of the inner blade subassembly 30 by first and second arms 46 and 47 that project in radially opposite directions from a central hub 49, which in the depicted embodiment comprises the distal portion of an outer shaft 48. The outer shaft 48 is tubular, and the inner shaft 38 is received concentrically within the outer shaft 48. Under this configuration, the inner shaft 38 and thus the first and second blades 32 and 34 of the inner blade subassembly 30 can be rotated in a first rotational direction, such as the counter-clockwise direction, while the outer shaft 48 and thus the first and second arms 46 and 47 and the first and second blades 42 and 44 of the outer blade subassembly 40 can be simultaneously rotated in a second, opposite rotational direction, such as the clockwise direction.

With particular reference to FIG. 23A, the first and second blades 32 and 34 of the inner blade subassembly 30, which are fixed in relation to the central hub 36, operate over an inner shaving zone Zᵢ. The first and second blades 42 and 44 of the outer blade subassembly 40, however, are pivotable about their proximal end portions in relation to the first and second arms 46 and 47 thereby establishing an adjustable outer shaving zone Zₒ. In each of the blade subassemblies 30 and 40, the first and second blades 32, 34, 42, and 44 are symmetrical and are oppositely disposed. While the inner and outer blade subassemblies 30 and 40 are each shown and described herein to comprise first and second blades 32, 34, 42, and 44, it will be understood that further or fewer blades 32, 34, 42, and 44 would be possible within the scope of the invention.

The first and second blades 32, 34 and 42, 44 of the inner and outer blade subassemblies 30 and 40 comprise what may be characterized as single facet chisel blades, each with a distal surface, a beveled proximal surface, and a shaving blade edge therebetween. The distal surfaces and the shaving blade edges of the first and second blades 32 and 34 of the inner blade subassembly 30 are disposed in a common plane with the distal surfaces and the shaving blade edges of the first and second blades 42 and 44 of the outer blade subassembly 40, and that common plane is perpendicular to the axis of rotation A of the inner and outer shafts 38 and 48. With this, the inner and outer blade subassemblies 30 and 40 will contact and operate on a frozen mix simultaneously.

The blade edges are disposed facing toward the rotational direction of travel of the respective blades 32, 34, 42, and 44. Where, as in this example, the inner blade subassembly 30 is designed for counter-clockwise rotation, the first and second blades 32 and 34 of the inner blade subassembly 30 have blade edges facing in the counter-clockwise direction, while the first and second blades 42 and 44 of the outer blade subassembly 40, which in this embodiment is configured to rotate in the clockwise direction, have blade edges facing in the clockwise direction. However, it will again be understood that the inner and outer blade subassemblies 30 and 40 and thus the first and second shaving blades 32, 34, 42, and 44 thereof could be configured for opposite rotation, namely with the inner blade subassembly 30 and the first and second blades 32 and 34 thereof configured for rotation in a clockwise direction and with the outer blade subassembly 40 and the first and second blades 42 and 44 thereof configured for rotation in a counter-clockwise direction.

The first and second blades 42 and 44 of the outer blade subassembly 40 are retained to pivot about vertical pivot axes at the distal ends of the first and second arms 46 and 47 respectively. The blade edges of the first and second blades 42 and 44 are angled to travel with the blade edges at a positive angle that projects across radii emanating from the axis of rotation A of the blade subassemblies 30 and 40 when the outer blade assembly 40 is rotated clockwise in this example. As a result, when the outer blade assembly 40 is rotated clockwise, the distal ends of the elongate first and second blades 42 and 44 travel rotationally ahead of the proximal ends of the blades 42 and 44. The blade edges of the first and second blades 42 and 44 can thus be considered to define the inner surfaces of the blades 42 and 44 while the opposite edges of the first and second blades 42 and 44 can be considered to define the outer surfaces of the blades 42 and 44.

Consequently, as the outer blade assembly 40 is rotated in a clockwise direction and applied to a frozen mix, the frozen mix exerts a force tending to pivot the first and second blades 42 and 44 outwardly thereby expanding the outer circumference of the outer shaving zone Zₒ. The blades 42 and 44 will then pivot outwardly until further outward pivoting of the blades 42 and 44 is prevented, such as by the wall 204 of the cup 200. Thus, when the outer blade subassembly 40 is rotated clockwise with the blades 42 and 44 in contact with a frozen mix, the first and second blades 42 and 44 are automatically pivoted counter-clockwise and outwardly from a retracted configuration toward an extended configuration. When the outer blade assembly 40 is rotated in reverse, which in this example is a counter-clockwise direction, the outward force on the first and second blades 42 and 44 is removed and replaced with an inward force as the blades 42 and 44 are rotationally pulled through the shaved frozen mix. The blades 42 and 44 are thus pivoted clockwise away from an extended configuration and toward a retracted configuration. In the embodiment of FIGS. 20 through 23B, the outer surfaces of the first and second blades 42 and 44 are broadened, smooth, and arcuate thereby facilitating a sliding of the blades 42 and 44 along the wall 204 of the cup 200 without cutting, tearing, or other damage.

The outer shaving zone Zₒ thus automatically self adjusts to the local diameter of the wall 204 of the cup 200 or other container 200 thereby permitting the shaving and blending assembly 16 to adapt to cups 200 of different sizes and to accommodate containers 200 with progressively tapered diameters as is common to paper cups. A clockwise pivoting of the outer blade subassembly 40 will pivot the first and second shaving blades 42 and 44 outwardly to extended configurations to increase the circumference traveled by the distal portions of the blades 42 and 44, and a counter-clockwise pivoting of the outer blade subassembly 40 will pivot the first and second shaving blades 42 and 44 inwardly to retracted configurations to decrease the circumference traveled by the distal portions of the blades 42 and 44. The first and second shaving blades 42 and 44 can, but need not necessarily, be biased inwardly to their retracted configurations, such by torsional springs incorporated into their pivot axes or otherwise.

Under the above-described construction, the outer shaving zone Zₒ established by the first and second blades 42 and 44 of the outer blade subassembly 40 has an inner diameter that is substantially fixed and an outer diameter that is adjustable to adapt automatically to different container diameters. Meanwhile, the inner shaving zone Zᵢ in this example of the invention is fixed in outer diameter with that outer diameter being marginally smaller than the inner diameter of the outer shaving zone Zₒ established by the first and second blades 42 and 44 of the outer blade subassembly 40. With that, the inner and outer blade assemblies 30 and 40 can be rotated in opposite directions without interference therebetween while shaving a frozen mix within the container 200 over substantially the entire surface of the frozen mix.

Where the shaving and blending assembly 16 is used to shave and blend a frozen mix potentially in combination with a liquid within a paper cup 200 that has a sidewall 204 with a winding direction and longitudinal ridges along the inner and outer surfaces of the cup 200 due to the overlapping paper forming the sidewall 204, the direction of rotation of the outer blade subassembly 40 will preferably match the direction of winding of the cup sidewall 204 and vice versa so that the first and second blades 42 and 44 will approach the ridge from behind. This will avoid having the distal ends of the first and second blades 42 and 44 of the outer blade assembly 40 dig into the inner ridge of the sidewall 204.

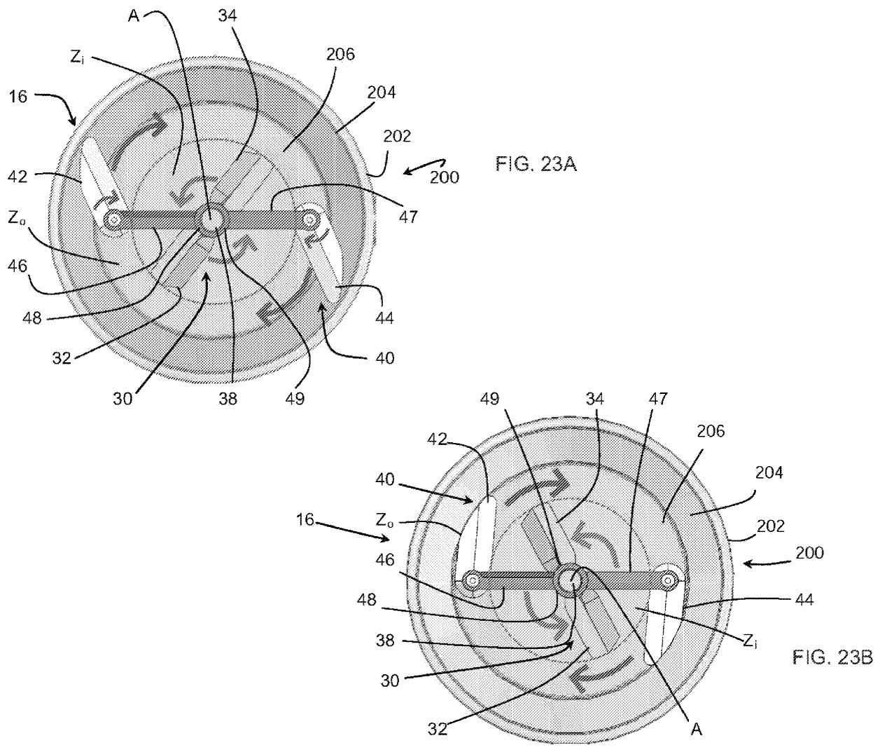

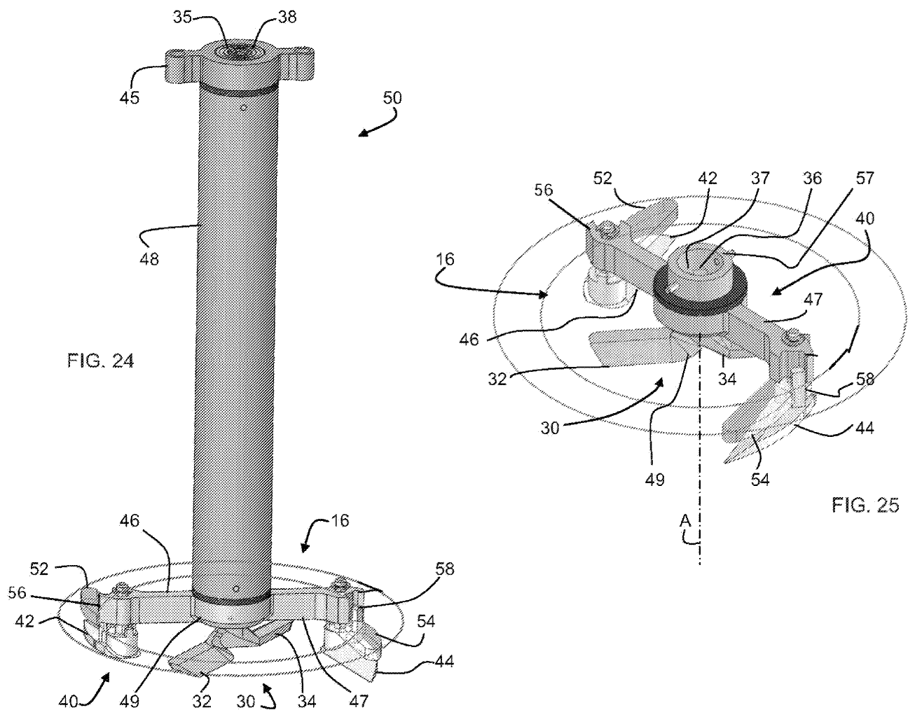

Another alternative embodiment of the shaving and blending assembly 16 is depicted in FIGS. 24, 25, and 27 through 29. There, the shaving and blending assembly 16 again incorporates counter-rotating inner and outer blade subassemblies 30 and 40. The inner blade subassembly 30 is rotatable by operation of an inner shaft 38 and again has first and second shaving blades 32 and 34 retained to project laterally outwardly from a central hub 36 in a fixed manner. The outer blade subassembly 40 has first and second shaving blades 42 and 44 pivotally retained by first and second arms 46 and 47 that project in radially opposite directions from a central hub 49.

In the depicted embodiment, the outer blade subassembly 40 can be selectively secured to the distal portion of an outer shaft 48 by an engagement mechanism 57, which could be of any effective type, such as but not limited to a snap-fit engagement, a threaded connection, retaining pins 57 as illustrated, or by any other engagement mechanism 57 or combination thereof. The outer shaft 48 is again tubular, and the inner shaft 38 is again received concentrically within the outer shaft 48 such that the inner shaft 38 and the inner blade subassembly 30 can be rotated in a first rotational direction, such as the counter-clockwise direction, while the outer shaft 48 and the outer blade subassembly 40 can be rotated in a second, opposite rotational direction, such as the clockwise direction.

The first and second blades 32 and 34 of the inner blade subassembly 30 are fixed in relation to the central hub 36 to operate over an inner shaving zone Zᵢ. The first and second blades 42 and 44 of the outer blade subassembly 40 establish an adjustable outer shaving zone Zₒ. The first and second blades 32, 34 and 42, 44 of the inner and outer blade subassemblies 30 and 40 again comprise single facet chisel blades, each with a distal surface in a plane perpendicular to the axis of rotation of the inner and outer shafts 38 and 48, a beveled proximal surface, and a shaving blade edge therebetween. The blade edges are disposed facing toward the rotational direction of travel of the respective blades 32, 34, 42, and 44.

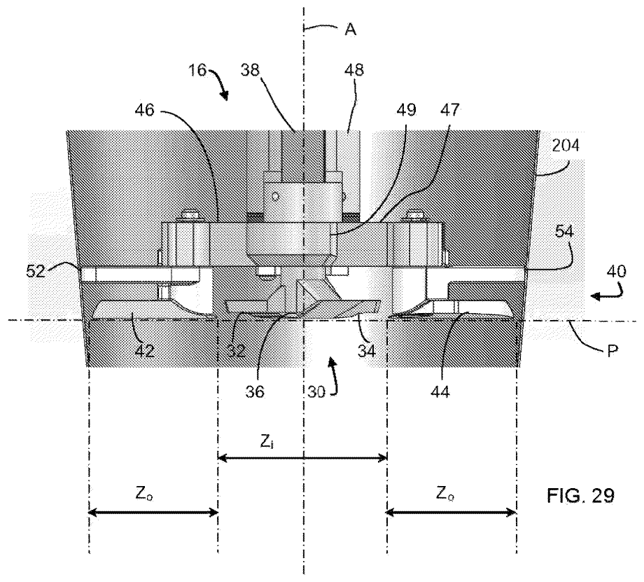

As best seen in FIG. 29, the blade edges and the distal surfaces of the first and second blades 32, 42 and 34, 44 of the inner and outer blade subassemblies 30 and 40 are disposed in a single plane P that is perpendicular to the common axis of rotation A of the blade subassemblies 30 and 40. With this, the blade edges and distal surfaces of the blades 32, 42 and 34, 44 of the inner and outer blade subassemblies 30 and 40 operate in that single plane P and will simultaneously contact, shave, and mix a frozen mix and potentially a liquid within the container 200 in a coplanar manner.

Again, by control of the geometry and relative size and rotational speed of the inner and outer blade subassemblies 30 and 40 and the blades 32, 34, 42, and 44 thereof, the net rotational force on the frozen mix within the container can be caused to approach zero. For instance, by selective calibration of the gear assembly 22 shown and described herein, the relative rotational speeds of the inner and outer blade assemblies 30 and 40 can be calibrated to cause the net rotational force on the frozen mix to be approximately nullified. Additionally or alternatively, the relative sizes and configurations of the blades 32, 34, 42, and 44 can be adjusted to approximate zero net rotational force. With that, the risk of undesirable spinning of the frozen mix can be eliminated with little or no reliance on other measures, such as rigid clamping and surface formations, as has typically been required of the prior art. Moreover, the shaving and blending system 10 can be operative in relation to a standard container 200, such as a simple paper cup 200, devoid of special features needed to prevent or minimize the inadvertent spinning of a retained frozen mix.

In the depicted embodiment, the first and second blades 42 and 44 are retained to pivot about vertical pivot axes that are parallel to the axis of rotation A of the blade subassemblies 30 and 40. The first and second blades 42 and 44 have blade edges angled to travel, when rotated clockwise as in this example, at a positive angle that projects forwardly across radii emanating from the axis of rotation A of the blade subassemblies 30 and 40. When the outer blade assembly 40 is rotated clockwise, the distal ends of the elongate first and second blades 42 and 44 thus travel rotationally ahead of the proximal ends of the blades 42 and 44. In this disposition, the blade edges of the first and second blades 42 and 44 define what may be referred to as the inner surfaces of the blades 42 and 44 while the opposite edges of the first and second blades 42 and 44 can be considered to define the outer surfaces of the blades 42 and 44.

As the outer blade assembly 40 of the present embodiment is rotated in a clockwise direction and applied to a frozen mix, the frozen mix exerts a force tending to press the first and second blades 42 and 44 outwardly to expand the outer circumference of the outer shaving zone Zₒ until further outward pivoting of the blades 42 and 44 is prevented, such as when restricted by the wall 204 of the cup 200. In the present embodiment, the outer surfaces of the first and second blades 42 and 44 again can be broadened, smooth, and arcuate to facilitate a sliding of the blades 42 and 44 along the wall 204 of the cup 200 without cutting, tearing, or other damage. However, the depicted embodiment further includes traveler members 52 and 54 that are fixed to pivot with the first and second blades 42 and 44. The traveler members 52 and 54 have outer surfaces that are smooth and arcuate and that extend radially outward of the outer surfaces of the first and second blades 42 and 44. With that, the traveler members 52 and 54 will make contact with and slide along the surface of the wall 204 while direct contact between the outer surfaces of the blades 42 and 44 and the wall 204 of the cup 200 is avoided.

The embodiment of the shaving and blending assembly 16 of FIGS. 24, 25, and 27-29 further incorporates range limiting formations 56 and 58 that are operative to prevent excess pivoting of the first and second blades 42 and 44 of the outer blade subassembly 40 in relation to the distal portions of the retaining arms 46 and 47. More particularly, as perhaps best seen in FIG. 25, the distal portions of the retaining arms 46 and 47 have alcoves formed therein while the first and second blades 42 and 44 have posts that project therefrom in parallel to the axis of rotation A of the shaving and blending assembly 16 to be received into the alcoves to form range limiting formations 56 and 58. With that, the first and second blades 42 and 44 have minimum inward orientations and maximum outward orientations such that excess pivoting of the first and second blades 42 and 44 inwardly and outwardly is prevented by engagement of the posts with the boundaries of the alcoves of the range limiting formations 56 and 58.

In each of the depicted embodiments, the inner and outer shafts 38 and 48 are longitudinally extendable and retractable and independently rotatable in relation to the housing 12 and in relation to the platform 14 and a retained container 200. The extension, retraction, and rotation of the inner and outer shafts 38 and 48 are motorized and can be manually or automatically controlled by operation of electronic software programmed into electronic memory of the system 10. In the depicted, non-limiting embodiment, a motor 24 is operable through a gear assembly 22 to rotate both the inner and outer shafts 38 and 48 and thus the inner and outer blade subassemblies 30 and 40. That same motor 24 or a separate motor can extend and retract the inner and outer shafts 38 and 48, potentially by raising and lowering the entire support stage structure 18, such as through rack and pinion gearing, a threaded engagement, or any other method, or by extending and retracting the shafts 38 and 48 independently of the support stage structure 18.

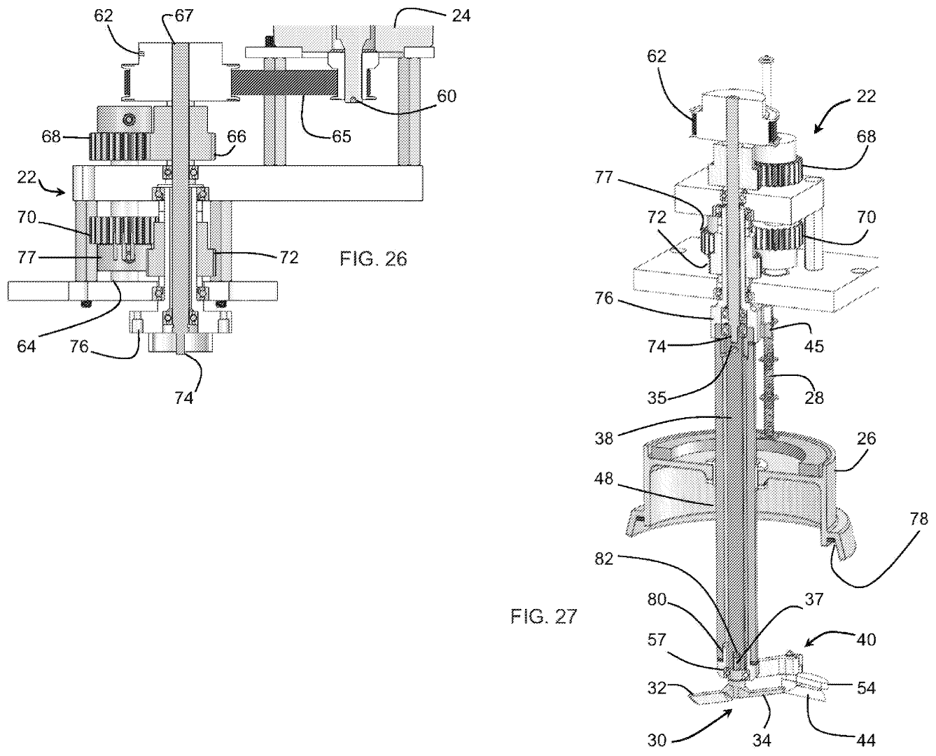

With particular reference to FIG. 26, the gear drive assembly 22 in this embodiment has an output pulley 60 that rotates with the output shaft of the motor 24. The output pulley 60 drives a belt 65 that in turn rotates a driven pulley 62 and, consequently, a drive shaft 67 that is fixed to rotate with the driven pulley 62. The drive shaft 67 has a distal engaging portion 74 adapted to selectively engage an engaging portion 35 of the inner shaft 38 such that rotation of the drive shaft 67 will produce a matching rotation of the inner shaft 38 and the inner blade subassembly 30. Selective engagement of the drive shaft 67 and the inner shaft 38 could be carried out in any effective manner, including by way of example and not limitation, keying, irregular, mating configurations, or any other mechanism or combination thereof.

The gear drive assembly 22 further establishes an opposite drive mechanism for rotating the outer shaft 48 in a rotational direction opposite that of the inner shaft 38. In this example, a gear 66 is fixed to rotate with the drive shaft 67 and to mesh with and rotate a gear 68 that is retained to rotate with a shaft 64 that is disposed in parallel with the drive shaft 67. A further gear 70 is fixed to rotate with the shaft 64 and to mesh with and rotate a reversing gear 77 which in turn meshes with and drives a gear 72 that is retained to rotate an output engaging portion 76 of the gear assembly 22 that can be selectively engaged with an engaging portion 45 that is fixed to rotate with the outer shaft 48. With this, a single motor 24 is operable to rotate the inner shaft 38 in a first rotational direction while rotating the outer shaft 48 in a second, opposite rotational direction. Moreover, the gearing drive assembly 22 can be configured to rotate the inner and outer blade subassemblies 30 and 40 at the same rotational speeds or a different speeds depending, for instance, on the desired interactions of the blade subassemblies 30 and 40 with the frozen mix.

The shaving and blending assembly 16 and the inner and outer shafts 38 and 48 can be readily attached and detached in relation to one another and in relation to the drive assembly 22, such as for cleaning, repair, or replacement. As shown in FIG. 24, for instance, the inner and outer shafts 38 and 48 can together form a sealed shaft assembly 50. The proximal ends of the inner and outer shafts 38 and 48 have selective engaging portions 35 and 45 that can be selectively coupled with engaging portions 74 and 76 of the drive assembly 22, and the distal ends of the inner and outer shafts 38 and 48 have selective engaging portions 82 and 80 for selectively coupling to engaging portions 37 and 57 of the shaving and blending assembly 16.

Any effective engaging portions 35, 37, 45, 57, 74, 76, 80 and 82 are within the scope of the invention except as expressly excluded by the claims. In the depicted embodiment, the engaging portions 37 and 74 comprise keyed projections while the engaging portions 82 and 74 comprise correspondingly keyed reception cavities. The engaging portion 57 of the shaving and blending assembly 16 comprises retaining pins 57 while the engaging portion 80 of the distal end of the outer shaft 48 comprises receiving apertures 80. Finally, the engaging portion 45 at the proximal end of the outer shaft 48 comprises protuberating ears 45 while the engaging portion 76 comprises receiving formations 76 for selectively receiving and engaging the ears 45. With this, the shaving and blending assembly 16, the shafts 38 and 48, and the drive assembly 22 can be readily disconnected and reconnected.

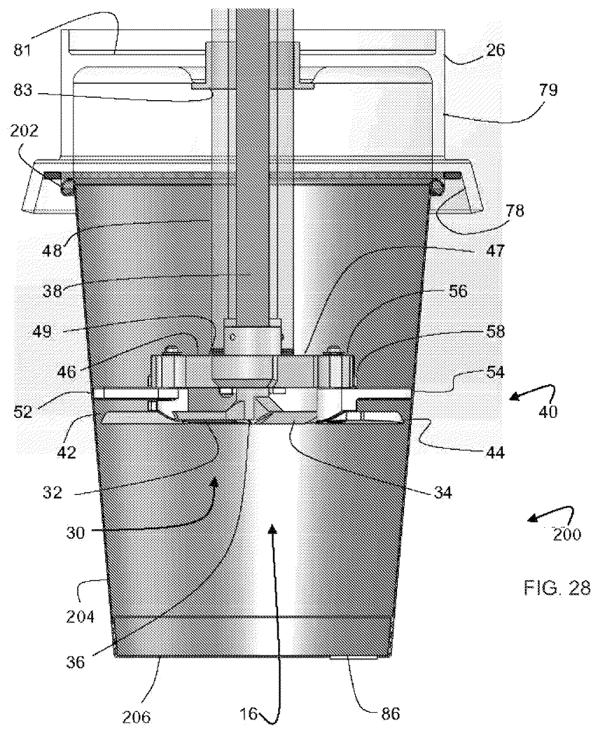

With combined reference to FIGS. 27 and 28, the bonnet cover 26 can be considered to have an annular dome shape. The cover 26 has a distally disposed stepped ring that establishes an annular interior shoulder 78. The cover 26 has an annular wall 79 that extends generally longitudinally from the shoulder 78 and a round top 81. An aperture 83 is concentrically disposed in the top 81 for receiving the shafts 38 and 48. The aperture 83 is sized to receive the shafts 38 and 48 closely but with free relative movement longitudinally and rotationally between the cover 26 and the shafts 38 and 48. The cover 26 is retained against rotation by retaining shafts 28 that extend from the stage structure 18 such that the retaining shafts 28 and the cover 26 travel therewith. With this, the shaving and blending assembly 16 and the cover 26 can be selectively lowered and raised into and out of engagement with the container 200 and the contents thereof.

In practices of the invention, the container 200 and the cover 26 are sized and constructed to produce a mating engagement between them and to establish a substantially enclosed volume defined by the wall 204 and the bottom 206 of the container 200 and the wall 79 and top 81 of the cover 26. More particularly, the cover 26 and the container 200 in the depicted example are relatively sized such that the rim 202 of the container 200 can be closely received into the ring of the cover 26 until the annular upper edge of the container rim 202 makes contact with the interior shoulder 78 of the cover 26.

Under such constructions, with a container 200 disposed atop the platform 14 in concentric alignment with the inner and outer shafts 38 and 48, the shaving and blending assembly 16 and the cover 26 can be extended into engagement with the container 200 and a liquid and frozen mix disposed therewithin whether by a lowering of the support structure 18 with the inner and outer shafts 38 and 48 and the shaving and blending assembly 16 retained thereby or by an extension of the inner and outer shafts 38 and 48 and the shaving and blending assembly 16. When lowered into place, the cover 26 enshrouds the container 200 to permit shaving and blending without a risk of spillage or mess. Once shaving and blending are complete, the cover 26 and the shaving and blending assembly 16 can be withdrawn from the container 200.

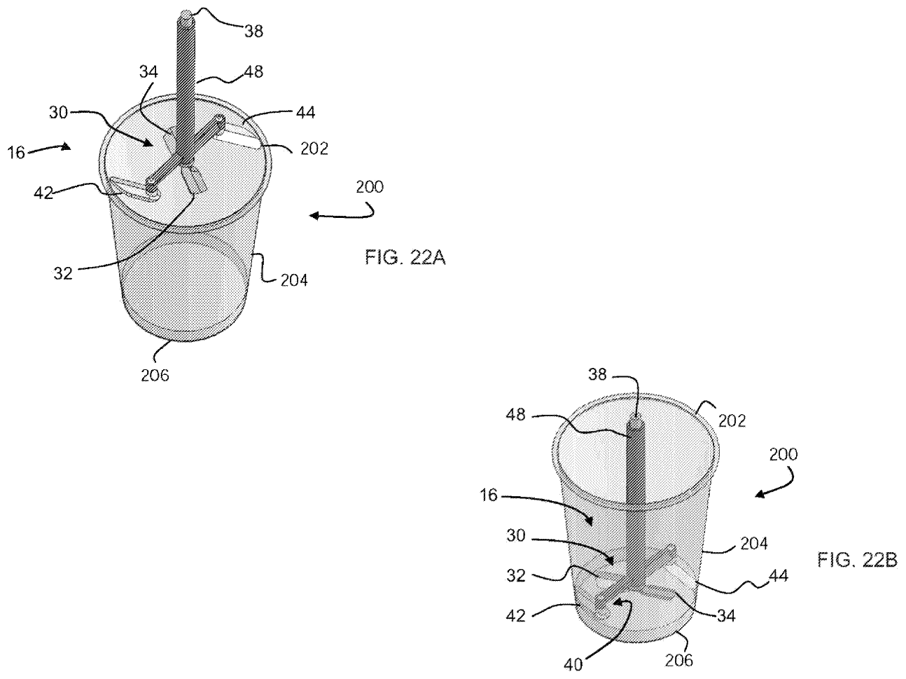

With the shaving and blending system 10 so constructed, a frozen mix and potentially an added liquid retained within a container 200 can be smoothly, quietly, and completely shaved and blended as can be understood with reference, for example, to FIGS. 22A through 23B. In an initial step, a cup 200 or other container 200 is engaged with the retention assembly 15 atop the support platform 14. Where the counter-rotating blade subassemblies 30 and 40 impart little or no net rotational force on the cup 200 or its frozen and liquid contents, the retention assembly 15 may, by way of example and not limitation, comprise a simple reception cavity in the platform 14. However, further and other retention assemblies are possible and within the scope of the invention, including reception shells, cinching or other clamping mechanisms, and any other retention assembly that will assist in locating and maintaining the container 200 concentric with the shaving and blending assembly 16.

Where a clamping mechanism is employed, it could, for instance, comprise a cinching clamp that constricts around the container 200, or it could comprise opposed clamping surfaces that can be selectively or automatically caused to press upon the outer wall 204 of the container 200 in opposition. The clamping mechanism can be operative to prevent rotation of the container 200 and, potentially, rotation of the frozen mix within the container 200 during shaving and blending. Where such opposed clamping surfaces are incorporated, they could comprise opposed arms that are movable laterally between a non-retaining position and a retaining position. Such opposed arms can be concavely contoured in correspondence to the shape of the cup 200, but other shapes, such as flat shapes or shapes with protuberances or other surface formations, are possible and within the scope of the invention except as it might be expressly limited by the claims.

Although ideally rendered unnecessary by the counter-rotation of the inner and outer blade subassemblies 30 and 40, it would nonetheless be possible within the scope of the invention except as the claims might expressly exclude for the container 200 to have interior ridges, fins, protuberances, or other features that are further operative to restrict rotation of the frozen mix relative to the container 200 prior to shaving.

In any event, with the cup 200 disposed atop the platform 14 in concentric alignment with the inner and outer shafts 38 and 48, the shaving and blending assembly 16 can be induced into operation, such as by actuation of a control panel on the system housing 12, by remote or other control, automatically, or by some combination thereof. The inner and outer shafts 38 and 48 and the retained shaving and blending assembly 16 and cover 26 can be extended by motorized operation of the system 10. Through the extension of the shafts 38 and 48, the shaving and blending assembly 16 is advanced into engagement with the cup 200 until the cover 26 receives and engages the rim 202 of the cup 200 to enshroud the inner volume of the cup 200. Then, the inner and outer shafts 38 and 48 can be induced into counter-rotation with the inner shaft 38 in this embodiment being rotated in a counter-clockwise manner and the outer shaft 48 is rotated in a clockwise manner.

With sufficient extension of the shafts 38 and 48, the blades 32, 34, 42, and 44 of the inner and outer blade subassemblies 30 and 40 will make simultaneous contact with any retained liquid and ultimately the frozen mix based on their coplanar, concentric relationship. Once in contact with the frozen mix, the counter-clockwise rotating inner blade subassembly 30 will begin shaving frozen mix over the inner shaving zone Zᵢ. Simultaneously, rotating clockwise, the outer blade subassembly 40 will begin shaving frozen mix over the annular outer shaving zone Zₒ surrounding the inner shaving zone Zᵢ. As the inner and outer blade assemblies 30 and 40 are counter-rotated, they are advanced longitudinally into the frozen mix thereby shaving away successive layers of frozen mix at a layer depth controlled by the rotational speed and rate of longitudinal advancement of the inner and outer shafts 38 and 48.

As the inner and outer blade subassemblies 30 and 40 delve deeper into the frozen mix, a controlled layer depth is shaved away with each rotation thereby yielding a smooth and consistent texture of the shaved mix. Moreover, by shaving at such a controlled depth, the shaving and blending assembly 16 can work effectively at a slower rotational speed, than for instance a prior art blender, to permit smoother and quieter operation.

Again, according to embodiments of the system 10, motor torque can be monitored, and the rotational speed and the rate of longitudinal advancement can be automatically adjusted, such as by computer software operative within the system 10, based thereon. Overall shaving and blending time can be optimized while producing a product of the desired shaving and blending characteristics and minimizing system wear and the risk of damage to the shaving and blending assembly 16 and the system 10 in general.

As the blades 42 and 44 of the self-adjusting outer blade assembly 40 shave the frozen mix, a constant outward force applied by the frozen mix presses the blades 42 and 44 outwardly thereby automatically adjusting the blades 42 and 44 in an outward lateral direction until further outward movement is restricted, such as by the outer surfaces of the blades 42 and 44 or the traveler members 52 and 54 making contact with the outer wall 204 of the cup 200. As the shaving and blending assembly 16 is further advanced into the frusto-conical inner volume of the cup 200, the self-adjusting nature of the outer blade assembly 40 permits an automatic, progressive adaptation of the outer diameter effectively traversed by the distal ends of the first and second blades 42 and 44 of the outer blade assembly 40 while the inner ends of the first and second blades 42 and 44 travel along a substantially consistent inner diameter. An automatically adjustable outer shaving zone Zₒ is thus established.

With a tapered cup 200 as illustrated, the narrowing outer wall 204 of the cup 200 will guide the distal ends of the blades 42 and 44 to a progressively narrowed configuration automatically adapting to the local diameter of the cup 200. With the automatically adjusting nature of the outer blade assembly 40 and with the coverage of the central portion of the frozen mix provided by the inner blade assembly 30, the entirety of the frozen mix both laterally across the cup 200 and from top to bottom can be shaved. As a consequence, icy chunks and other solid portions are minimized or eliminated. Moreover, to the extent necessary, the shaving and blending assembly 16 can automatically adjust to cups 200 and other containers 200 of varying diameters, tapers, and other characteristics.

Once the shaving process is complete, such as when the shaving and blending assembly 16 reaches the bottom 206 of the cup 200 or is within a predetermined distance thereof, further advancement of the shafts 38 and 48 is terminated and rotation of the shafts 38 and 48 is ceased. Then, the rotations of the shafts 38 and 48 can be reversed, and the shafts 38 and 48 and the shaving and blending assembly 16 can be progressively retracted toward a raised position. As the rotation of the outer shaft 48 is reversed, in this case to the counter-clockwise direction, the self-adjusting outer blade assembly 40 will automatically self-adjust toward a retracted configuration as the first and second blades 42 and 44 are pulled through the shaved frozen mix with their distal ends rotationally trailing their proximal ends. The shaved frozen mix thus applies a contractive force to the blades 42 and 44.

As the shafts 38 and 48 and the shaving and blending assembly 16 are rotated and retracted, the shaven mix and any added liquid are smoothly blended. When the shaving and blending assembly 16 has risen above the now shaved and blended mix, but potentially while the shaving and blending assembly 16 remains below the upper edge of the rim 202 of the cup 200 or at least while enshrouded by the cover 26, the shafts 38 and 48 and the inner and outer blade subassemblies 30 and 40 can be rapidly spun to clear all remaining mix from the blade subassemblies 30 and 40 and to deposit the same within the cup 200. Then, the shafts 38 and 48 and the shaving and blending assembly 16 can be adjusted to a retracted position. The cup 200 can then be removed from the retention assembly 16, and the now shaved and blended mix within the cup 200 can be enjoyed.

Again, as FIG. 28 shows, each container 200 can have an identifier 86 thereon or therein. The identifier 86 could be unique to the individual container 200. Alternatively or additionally, series, types, or groups of containers 200 can have series, type, or group identifiers 86. The identifiers 86 can, by way of example and not limitation, be two-dimensional codes, such as numerical, bar, or quick response (QR) codes. Additionally or alternatively, the identifiers 86 could comprise electronic identifiers, such as but not limited to radiofrequency identification (RFID) micro chips or other electronic identifiers. As FIG. 20 illustrates, the shaving and blending system 10 can again incorporate a reader 88 for detecting the identifier 86 and, through the identifier 86, the container 200 and, potentially, the frozen mix contained in the container 200. As previously described, the shaving and blending system 10 can be operative based on the detected identifier 86, such as dependent on the detected frozen mix within the container 200 as indicated by the identifier 86, by a lack of an identifier 86 authenticated by the reader 88, or by a detection that the contents of a given identified container 200 have already been shaved and blended.

With certain details and embodiments of the present invention for a shaving and blending system 10 disclosed, it will be appreciated by one skilled in the art that numerous changes and additions could be made thereto without deviating from the spirit or scope of the present invention. This is particularly true when one bears in mind that the presented preferred embodiments merely exemplify the broader invention revealed herein. Features, relationships, and relative dimensions shown in the drawings are intended merely to be illustrative and informative but not limiting. Accordingly, it will be clear that those with major features in mind could craft embodiments that incorporate those major features while not incorporating all of the features included in the preferred embodiments.

Therefore, the following claims shall define the scope of protection to be afforded to the invention. Those claims shall be deemed to include equivalent constructions insofar as they do not depart from the spirit and the scope of the invention. It must be further noted that a plurality of the following claims may express, or be interpreted to express, certain elements as means of performing a specific function, at times without the recital of structure of material. As the law demands, any such claim shall be construed to cover not only the corresponding structure and material expressly described in this specification but also all legally-cognizable equivalents thereof.

What is claimed as deserving of Letters Patent is:

1. A shaving and blending system for shaving and blending a frozen mix within a container with a rim, a sidewall, and a bottom, the shaving and blending system comprising:
a rotatable inner blade subassembly with at least one blade with a blade edge for shaving the frozen mix over an inner shaving zone Zᵢ wherein the inner blade subassembly is adapted to shave the frozen mix in a first rotational direction;
a rotatable outer blade subassembly with at least one blade with a blade edge for shaving the frozen mix over an outer shaving zone Zₒ wherein the outer blade subassembly is concentric with the inner blade subassembly and wherein the outer blade subassembly is adapted to shave the frozen mix in a second rotational direction opposite the first rotational direction;
wherein the inner blade subassembly and the outer blade subassembly are rotatable about a common rotational axis to form a shaving and blending assembly;
whereby the shaving and blending system can shave and blend the frozen mix within the container over the inner and outer shaving zones Zᵢ and Zₒ by a rotation of the inner blade subassembly in the first rotational direction and a simultaneous rotation of the outer blade subassembly in the second rotational direction.

2. The shaving and blending system of claim 1, wherein the outer shaving zone Zₒ established by the outer blade subassembly has an inner diameter that is substantially fixed and an outer diameter that is adjustable to adapt to different diameters of the sidewall of the container.

3. The shaving and blending system of claim 2, wherein the inner shaving zone Zᵢ established by the inner blade subassembly is fixed in outer diameter.

4. The shaving and blending system of claim 3, wherein the outer diameter of the inner shaving zone Zᵢ established by the inner blade subassembly is smaller than the inner diameter of the outer shaving zone Zₒ established by the outer blade subassembly.

5. The shaving and blending system of claim 1, wherein the at least one blade of the inner blade subassembly and the at least one blade of the outer blade subassembly have blade edges in a common plane perpendicular to the rotational axis whereby, during shaving of the frozen mix, the inner blade subassembly will impart a rotational force on the frozen mix in the first rotational direction while the outer blade subassembly will simultaneously impart a rotational force on the frozen mix in the second rotational direction.

6. The shaving and blending system of claim 1, wherein the inner blade subassembly has first and second blades that project in substantially opposite directions from the rotational axis.

7. The shaving and blending system of claim 1, wherein the at least one blade of the outer blade subassembly has a proximal end and a distal end and wherein the at least one blade of the outer blade subassembly is pivotally retained by the proximal end thereof whereby the outer shaving zone Zₒ is adjustable in outer diameter.

8. The shaving and blending system of claim 7, wherein the blade edge of the at least one blade of the outer blade subassembly is angled to travel when rotated for shaving at an outward angle relative to a radius emanating from the rotational axis and with the distal end of the at least one blade of the outer blade subassembly disposed rotationally ahead of the proximal end of the at least one blade of the outer blade subassembly whereby, when the outer blade subassembly is rotated in the second rotational direction to shave the frozen mix, the frozen mix will tend to exert a force pressing the at least one blade to pivot outwardly thereby expanding an outer circumference of the outer shaving zone Zₒ.

9. The shaving and blending system of claim 8, wherein the outer blade subassembly has first and second blades, each with a proximal end and a distal end and each pivotally retained by the proximal end thereof, wherein the blade edges of the first and second blades of the outer blade subassembly are angled to travel when rotated for shaving at an outward angle relative to a radius emanating from the rotational axis and with the distal ends of the first and second blades of the outer blade subassembly disposed rotationally ahead of the proximal ends of the first and second blades of the outer blade subassembly whereby, when the outer blade subassembly is rotated in the second rotational direction to shave the frozen mix, the frozen mix will tend to exert a force pressing the first and second blades of the outer blade subassembly to pivot outwardly thereby expanding an outer circumference of the outer shaving zone Zₒ.

10. The shaving and blending system of claim 7, further comprising a traveler member fixed to pivot with the at least one blade of the outer blade subassembly wherein the traveler member has an outer surface that is smooth and arcuate and that is disposed radially outward of an outer surface of the at least one blade of the outer blade subassembly whereby direct contact between the outer surface of the at least one blade of the outer blade subassembly and the sidewall of the container is avoided.

11. The shaving and blending system of claim 1, further comprising a tubular outer shaft and an inner shaft concentrically received within the outer shaft wherein the inner blade subassembly is adapted to be retained by and to rotate with the inner shaft and wherein the outer blade subassembly is adapted to be retained by and to rotate with the outer shaft.

12. The shaving and blending system of claim 11, further comprising a motor with an output shaft, a drive assembly for rotating the inner blade subassembly in the first rotational direction in response to a rotation of the output shaft by the motor in a first rotational direction of the motor, and a drive assembly for rotating the outer blade subassembly in the second rotational direction in response to the rotation of the output shaft by the motor in the first rotational direction of the motor.

13. The shaving and blending system of claim 11, further comprising a bonnet cover concentrically retained relative to the inner and outer shafts and the inner and outer blade subassemblies to enshroud the container when the shaving and blending assembly formed by the inner blade subassembly and the outer blade subassembly is extended to engage the container wherein the bonnet cover has a container sealing ring with a diameter for engaging the rim of the container.

14. The shaving and blending system of claim 13, further comprising a container holder with a retainer cup for selectively receiving and retaining the container wherein the retainer cup has an upper rim and wherein the bonnet cover further comprises a container holder sealing ring for engaging the upper rim of the retainer cup of the container holder wherein the container holder sealing ring has a diameter greater than the diameter of the container sealing ring whereby the bonnet cover can enshroud the retainer cup of the container holder.

15. The shaving and blending system of claim 1, further comprising a container with an inner volume for retaining a frozen mix.

16. The shaving and blending system of claim 15, further comprising an identifier retained by the container.

17. The shaving and blending system of claim 15, further comprising a frozen mix disposed within the inner volume of the container wherein the frozen mix contained comprises a frozen suspension.

18. A shaving and blending system for shaving and blending a frozen mix within a container with a rim, a sidewall, and a bottom, the shaving and blending system comprising:
a blade subassembly with at least one blade with a blade edge for shaving the frozen mix over a shaving zone wherein the blade subassembly is adapted to shave the frozen mix in a rotational direction about a rotational axis;
wherein the at least one blade of the blade subassembly has a proximal end and a distal end and wherein the at least one blade of the blade subassembly is pivotally retained by the proximal end thereof whereby the shaving zone is adjustable in outer diameter.

19. The shaving and blending system of claim 18, wherein the blade edge of the at least one blade of the blade subassembly is angled to travel when rotated for shaving at an outward angle relative to a radius emanating from the rotational axis and with the distal end of the at least one blade of the blade subassembly disposed rotationally ahead of the proximal end of the at least one blade of the blade subassembly whereby, when the blade subassembly is rotated in the rotational direction to shave the frozen mix, the frozen mix will tend to exert a force pressing the at least one blade to pivot outwardly thereby expanding an outer circumference of the shaving zone.

20. The shaving and blending system of claim 18, wherein the blade subassembly has first and second blades, each with a proximal end and a distal end and each pivotally retained by the proximal end thereof, wherein the blade edges of the first and second blades of the blade subassembly are angled to travel when rotated for shaving at an outward angle relative to a radius emanating from the rotational axis and with the distal ends of the first and second blades of the blade subassembly disposed rotationally ahead of the proximal ends of the first and second blades of the blade subassembly whereby, when the blade subassembly is rotated in the rotational direction to shave the frozen mix, the frozen mix will tend to exert a force pressing the first and second blades of the blade subassembly to pivot outwardly thereby expanding an outer circumference of the shaving zone.

21. The shaving and blending system of claim 18, further comprising a traveler member fixed to pivot with the at least one blade of the blade subassembly wherein the traveler member has an outer surface that is smooth and arcuate and that is disposed radially outward of an outer surface of the at least one blade of the blade subassembly whereby direct contact between the outer surface of the at least one blade of the blade subassembly and the sidewall of the container is avoided.

22. The shaving and blending system of claim 18, wherein the blade subassembly comprises an outer blade subassembly for shaving the frozen mix over an outer shaving zone Zₒ and further comprising a rotatable inner blade subassembly with at least one blade with a blade edge for shaving the frozen mix over an inner shaving zone Zᵢ at least partially interior to the outer shaving zone Zₒ wherein the inner and outer blade subassemblies (30, 40) cooperate to form a shaving and blending assembly and wherein the inner blade subassembly is adapted to shave the frozen mix in a first rotational direction, wherein the outer blade subassembly is concentric with the inner blade subassembly, wherein the outer blade subassembly is adapted to shave the frozen mix in a second rotational direction opposite the first rotational direction, and wherein the inner blade subassembly and the outer blade subassembly are rotatable about a common rotational axis whereby the shaving and blending system can shave and blend the frozen mix within the container over the inner and outer shaving zones Zᵢ and Zₒ by a rotation of the inner blade subassembly in the first rotational direction and a simultaneous rotation of the outer blade subassembly in the second rotational direction.

23. The shaving and blending system of claim 22, wherein the at least one blade of the inner blade subassembly and the at least one blade of the outer blade subassembly have blade edges in a common plane perpendicular to the rotational axis whereby, during shaving of the frozen mix, the inner blade subassembly will impart a rotational force on the frozen mix in the first rotational direction while the outer blade subassembly will simultaneously impart a rotational force on the frozen mix in the second rotational direction.

24. The shaving and blending system of claim 22, wherein the inner blade subassembly has first and second blades that project in substantially opposite directions from the rotational axis.

25. The shaving and blending system of claim 22, wherein the inner shaving zone Zᵢ established by the inner blade subassembly is fixed in outer diameter.

26. The shaving and blending system of claim 25, wherein the outer shaving zone Zₒ has an inner diameter and wherein the outer diameter of the inner shaving zone Zᵢ established by the inner blade subassembly is smaller than the inner diameter of the outer shaving zone Zₒ established by the outer blade subassembly.

27. The shaving and blending system of claim 22, further comprising a tubular outer shaft and an inner shaft concentrically received within the outer shaft wherein the inner blade subassembly is adapted to be retained by and to rotate with the inner shaft and wherein the outer blade subassembly is adapted to be retained by and to rotate with the outer shaft.

28. The shaving and blending system of claim 27, further comprising a motor with an output shaft, a drive assembly for rotating the inner blade subassembly in the first rotational direction in response to a rotation of the output shaft by the motor in a first rotational direction of the motor, and a drive assembly for rotating the outer blade subassembly in the second rotational direction in response to the rotation of the output shaft by the motor in the first rotational direction of the motor.

29. The shaving and blending system of claim 27, further comprising a bonnet cover concentrically retained relative to the inner and outer shafts and the inner and outer blade subassemblies to enshroud the container when the shaving and blending assembly is extended to engage the container wherein the bonnet cover has a container sealing ring with a diameter for engaging the rim of the container.

30. The shaving and blending system of claim 29, further comprising a container holder with a retainer cup for selectively receiving and retaining the container wherein the retainer cup has an upper rim and wherein the bonnet cover further comprises a container holder sealing ring for engaging the upper rim of the retainer cup of the container holder wherein the container holder sealing ring has a diameter greater than the diameter of the container sealing ring whereby the bonnet cover can enshroud the retainer cup of the container holder.
